(19) United States
(12) Patent Application Publication
(10) Pub. No.: US 2025/0272793 A1
(43) Pub. Date: Aug. 28, 2025

(54) METHODS AND SYSTEMS FOR COUNTER SCAN AREA MODE IMAGING

(71) Applicant: Ultima Genomics, Inc., Fremont, CA (US)

(72) Inventors: Gilad ALMOGY, Palo Alto, CA (US); Osip SCHWARTZ, Lafayette, CA (US); Rongwen LU, Fremont, CA (US); Gene POLOVY, San Francisco, CA (US); Amy Elizabeth FRANTZ, Cherry Hill, NJ (US)

(21) Appl. No.: 19/198,945

(22) Filed: May 5, 2025

Related U.S. Application Data
(63) Continuation of application No. PCT/US2023/079198, filed on Nov. 9, 2023.
(60) Provisional application No. 63/424,446, filed on Nov. 10, 2022.

(51) Int. Cl. G06T 5/50; G01N 21/64; G06T 5/73; G06T 5/90

(52) U.S. Cl. CPC G06T 5/50; G01N 21/6456; G06T 5/73; G06T 5/90; G01N 2201/105; G06T 2207/10064; G06T 2207/10152; G06T 2207/20208; G06T 2207/20212

(57) ABSTRACT

Methods and systems for compensating for relative motion between an optical detection system and an object to be optically interrogated are described. In some instances, the method may comprise: redirecting light transmitted, reflected, or emitted by an object onto one or more optical sensors in a time-dependent manner to correct for relative motion between the object and the one or more optical sensors, wherein an area of the object from which the transmitted, reflected, or emitted light arises corresponds to a field-of-view for the one or more optical sensors, and wherein the time-dependent redirecting of the transmitted, reflected, or emitted light results in a substantially motion-invariant delivery of an optical signal to the one or more optical sensors for a specified signal acquisition time.

### CROSS-REFERENCE TO RELATED APPLICATIONS

This application is a continuation application of PCT/US2023/079198, filed internationally on Nov. 9, 2023, which claims the priority benefit of U.S. Provisional Patent Application Ser. No. 63/424,446, filed Nov. 10, 2022, the contents of which are incorporated herein by reference in their entirety.

### FIELD

The present disclosure relates generally to methods and systems that correct for relative motion between an object and an optical sensor used to acquire optical signals arising from the object, and more specifically to methods and systems that correct for relative motion between an object to be imaged and an image sensor used to image the object.

### BACKGROUND

In both industrial and scientific settings there is often a need to image, or otherwise optically survey, an object that is larger than the field-of-view of the optical system. Often, the object may be optically surveyed by moving the object relative to the optical system (or vice versa). A system that collects data from an object by positioning different areas of the object in the field-of-view of an optical detection system can be called an optical scanning system.

Optical scanning systems may be configured in a variety of ways. For example, in one common approach, an optical scanning optical system can be implemented using a cyclical sequence of steps comprising: (i) acquiring an image (or otherwise collecting optical signal data) from a first area of an object, (ii) moving the object relative to the optical detection system (or vice versa) to a second area of the object, (iii) acquiring an image (or otherwise collecting optical signal data) from the second area of the object, and so forth. This process may be repeated to acquire images (or collect data) until all areas of interest in the object have been surveyed. In general, this approach has the disadvantage that the system must alternate between steps of maintaining the object at a fixed relative position to the optical detection system for as long as necessary to acquire the optical data and moving the object (or the optical detection system) towards the next data acquisition position. This stop-and-go motion entails acceleration and deceleration of the object (or of the optical system), which takes time and limits the throughput of the optical scanning system. It can also complicate the design of the system to ensure that it is capable of providing the necessary acceleration and deceleration capability as well as withstanding the jarring motion of alternating accelerations and decelerations.

Line scanning is one example of a conventional approach to enabling continuous acquisition of optical data concurrently with the relative motion taking place between an object and an optical detection system. Correction for the relative motion is achieved by the use of line-scan cameras or time-delay integration (TDI) cameras, which allow for data acquisition or image acquisition from a moving object.

It is often desirable, however, to use a conventional area mode optical detector (e.g., an image sensor) instead of a TDI detector for optical data collection. The advantages of using an area mode detector can include, but are not limited to, any of the following: higher data collection throughput (in terms of either data rate measured in bits per second, or pixel read-out rate in pixels per second), higher throughput per a given field-of-view (FOV), lower costs, and/or a larger variety of commercially-available sensors, thereby leading to a more optimal choice of sensor for a given application.

Another general advantage of optical detection systems based on the use of an area mode optical detector (e.g., an image sensor) is that they can provide a higher fill factor for the field-of-view of a typical optical imaging system. Conventional optical imaging systems are built from cylindrically symmetric optical elements and therefore possess a rotational symmetry with respect to the optical axis. Accordingly, most imaging systems, including most microscopes, have a circular field-of-view. However, high throughput TDI cameras tend to have large aspect ratios (e.g., high-end TDI cameras can be 8192 pixels wide and 128 pixels deep; or 16384 pixels wide and 256 pixels deep). Therefore, the camera's active area only covers a small portion of the circular image plane (e.g., a rectangular portion located near the diameter of the circular field-of-view). On the other hand, area mode sensors (e.g., image sensors) can have an aspect ratio close to unity, and therefore may cover a much larger portion of the image plane. Thus, scanning systems based on area mode optical sensors have the potential to provide higher throughput data collection than TDI systems at the same FOV, or comparable throughput at a smaller FOV.

However, in order to take advantage of area mode optical detectors in the design of optical detection systems for scanning applications where there is relative motion between the object of interest and the optical detection system, a method for correcting for the relative motion is required.

### BRIEF SUMMARY OF THE INVENTION

Disclosed herein are methods and systems for performing continuous optical data collection (scanning) using area mode optical systems and an approach termed Counter-scan Area Mode Strobe (CAMS) that corrects for arbitrary combinations of linear and/or rotational relative motion between the object of interest and the optical detection system.

In the disclosed methods and systems, the CAMS optical detection system includes a counter-scan subsystem comprising at least one component that has time-dependent optical properties and is synchronized with the relative motion between the object and the detection system to correct for motion-induced smearing or blurring. In some instances, the counter-scan subsystem may be designed to redirect light transmitted, reflected, or emitted by an object onto one or more optical sensors in a time-dependent manner such that a substantially motion-invariant optical signal is delivered to the one or more optical sensors for a specified signal acquisition time. In some instances, the counter-scan subsystem may be designed to redirect light transmitted, reflected, or emitted by an object onto one or more image sensors in a time-dependent manner such that a substantially static image of the object on the one or more image sensors for a specified image acquisition time. In some instances, the counter-scan subsystem may be designed to synchronously scan both an illumination light field (e.g., uniform illumination or structured illumination) projected onto the object and the light collected from the object and redirected to the one or more optical sensors (e.g., one or more image sensors) to maintain delivery of a substantially motion-invariant signal to the one or more optical sensors (e.g., to form a substantially static image on the one or more image sensors).

The advantages of the disclosed methods and systems may include: i) higher throughput data collection rates (in terms of either data rate (bits per second) or pixel read-out rate (pixels per second)), ii) higher throughput imaging at a given field-of-view, iii) compensation for both linear and rotational relative motion, or an arbitrary combination thereof, between the object of interest and the optical detection system, iv) more accurate compensation for relative motion than can be achieved using a comparable TDI line scanning system (thus enabling use of longer signal integration times and/or reducing smearing or blurring of optical signals), v) providing higher fill factors than a TDI camera-based detection system for the field-of-view of a typical imaging optical imaging system, vi) lower optical detection system costs, or any combination thereof.

Disclosed herein are methods comprising: changing a deflection angle of light relayed within an optical system and projected onto one or more optical sensors using at least one optical component having a time-dependent orientation to correct for relative motion between an object and the one or more optical sensors, wherein the change in deflection angle results in delivery of a motion-invariant optical signal to the one or more optical sensors for a specified signal acquisition time.

In some embodiments, the light projected onto the one or more optical sensors comprises light that is transmitted, reflected, or emitted by the object.

In some embodiments, illumination light is projected onto an area of the object that is greater than or equal to an area of a field-of-view of the one or more optical sensors for the specified signal acquisition time. In some embodiments, an angle of illumination light projected onto the object is changed using at least one optical component having a time-dependent orientation to correct for relative motion between the object and a light source that provides the illumination light. In some embodiments, the illumination light projected onto the object comprises an area of substantially uniform illumination light intensity. In some embodiments, the light source comprises a laser. In some embodiments, the laser comprises a pulsed laser that is synchronized with signal acquisition. In some embodiments, the illumination light projected onto the object provides structured illumination.

In some embodiments, changing the deflection angle of light projected onto the one or more optical sensors is repeated for two or more signal acquisition cycles, each cycle comprising a signal acquisition step and a rewind step, to acquire optical signals corresponding to two or more areas of the object. In some embodiments, the two or more areas are contiguous.

In some embodiments, the one or more optical sensors have a same field-of-view. In some embodiments, the one or more optical sensors have different fields-of-view.

In some embodiments, the relative motion between the object and the one or more optical sensors comprises linear motion, rotational motion, or any combination thereof within a two-dimensional plane. In some embodiments, the relative motion between the object and the one or more optical sensors comprises rotational motion within a two-dimensional plane.

In some embodiments, changing the deflection angle of light projected onto the one or more optical sensors comprises the use of two or more galvo-mirrors. In some embodiments, the two or more galvo-mirrors are positioned between an objective lens and a tube lens used to relay the optical signal to the one or more optical sensors. In some embodiments, the two or more galvo-mirrors are positioned between a tube lens used to relay the optical signal and the one or more optical sensors. In some embodiments, each of the two or more galvo-mirrors have two tilt axes, and at least one of the two tilt axes is perpendicular to a two-dimensional plane within which the relative motion between the object and the one or more optical sensors occurs.

In some embodiments, changing the deflection angle of light projected onto the one or more optical sensors comprises the use of a rotational stage on which the one or more optical sensors are mounted and a reflector comprising at least one axis of tilt. In some embodiments, the reflector comprises a dichroic mirror.

In some embodiments, changing the deflection angle of light projected onto the object to the one or more optical sensors comprises the use of a polygon mirror, a micromirror array, an acousto-optic deflector, a liquid crystal element, a liquid crystal array, or any combination thereof.

In some embodiments, changing the deflection angle of light projected onto the object to the one or more optical sensors comprises the use of a tiltable objective lens to create a magnification gradient across a field-of-view of the one or more optical sensors. In some embodiments, changing the deflection angle of light projected onto the object to the one or more optical sensors further comprises the use of a tiltable tube lens or a tiltable image sensor.

In some embodiments, the method further comprises: acquiring a first optical signal from an area of the object within the specified signal acquisition time using a first illumination light intensity; acquiring a second optical signal from the area of the object within the specified signal acquisition time using a second illumination light intensity that is different from the first illumination light intensity; and combining the first optical signal and the second optical signal to generate a combined optical signal having a higher dynamic range that the first optical signal or the second optical signal. In some embodiments, the first optical signal and the second optical signal are acquired using a same optical sensor in two separate signal acquisition steps within the specified signal acquisition time. In some embodiments, the first optical signal and the second optical signal are acquired using different optical sensors in a same signal acquisition step within the signal acquisition time. In some embodiments, the dynamic range of the combined optical signal is at least 2×, 5×, 10×, 15×, or 20× higher than the dynamic range of the first or second optical signals.

In some embodiments, the method further comprises acquiring a plurality of optical signals from an area of the object within the specified signal acquisition time, wherein each of the plurality of optical signals is acquired using a different illumination condition. In some embodiments, the different illumination conditions comprise a different light intensity, a different illumination pattern, a different illumination wavelength, or any combination thereof. In some embodiments, the plurality of optical signals is acquired using a plurality of optical sensors in a same signal acquisition step within the specified signal acquisition time. In some embodiments, the plurality of optical signals is acquired using a same optical sensor in a plurality of different signal acquisition steps within the specified signal acquisition time. In some embodiments, the plurality of optical signals is acquired using a same optical sensor in a plurality of different signal acquisition steps at different times.

In some embodiments, a time-dependence of changing the deflection angle of light projected onto the one or more optical sensors is periodically or continuously adjusted to synchronize the change in angle with changes in the relative motion between the object and the one or more optical sensors. In some embodiments, the time-dependence of changing the deflection angle of light projected onto the one or more optical sensors is periodically or continuously adjusted without the use of a feedback mechanism.

In some embodiments, the relative motion between the object and the one or more optical sensors comprises rotational motion in a two-dimensional plane, and the acquired optical signals correspond to two or more areas of the object that comprise a circular segment of the object.

In some embodiments, the relative motion between the object and the one or more optical sensors comprises a combination of linear and rotational motion in a two-dimensional plane, and the acquired optical signals correspond to two or more areas of the object that comprise a spiral segment of the object.

In some embodiments, the optical signal comprises a fluorescence signal. In some embodiments, the object comprises a substrate, wafer, or flow cell for nucleic acid sequencing.

Also disclosed herein are methods for imaging comprising: changing a deflection angle of light relayed within an optical system and projected onto one or more image sensors using at least one optical component having a time-dependent orientation to correct for relative motion between an object to be imaged and the one or more image sensors, wherein the change in deflection angle results in formation of a static image of the object on the one or more image sensors for a specified image acquisition time.

In some embodiments, the light projected onto the one or more image sensors comprises light that is transmitted, reflected, or emitted by the object.

In some embodiments, illumination light is projected onto an area of the object that is greater than or equal to an area of a field-of-view of the one or more image sensors for the specified image acquisition time. In some embodiments, an angle of illumination light projected onto the object is changed using at least one optical component having a time-dependent orientation to correct for relative motion between the object and a light source that provides the illumination light. In some embodiments, the illumination light projected onto the object comprises an area of substantially uniform illumination light intensity. In some embodiments, the light source comprises a laser. In some embodiments, the laser comprises a pulsed laser that is synchronized with image acquisition. In some embodiments, the illumination light projected onto the object provides structured illumination.

In some embodiments, changing the deflection angle of light projected onto the one or more image sensors is repeated for two or more image acquisition cycles, each cycle comprising an image acquisition step and a rewind step, to acquire images of two or more areas of the object. In some embodiments, the two or more areas are contiguous.

In some embodiments, the one or more image sensors have a same field-of-view. In some embodiments, the one or more image sensors have different fields-of-view.

In some embodiments, the relative motion between the object and the one or more image sensors comprises linear motion, rotational motion, or any combination thereof, within a two-dimensional plane. In some embodiments, the relative motion between the object and the one or more optical sensors comprises rotational motion within a two-dimensional plane.

In some embodiments, changing the deflection angle of light projected onto the one or more image sensors comprises the use of two or more galvo-mirrors. In some embodiments, the two or more galvo-mirrors are positioned between an objective lens and a tube lens used to form the image on the one or more image sensors. In some embodiments, the two or more galvo-mirrors are positioned between a tube lens used to form the image and the one or more image sensors. In some embodiments, each of the two or more galvo-mirrors have two tilt axes, and at least one of the two tilt axes is perpendicular to a two-dimensional plane within which the relative motion between the object and the one or more optical sensors occurs.

In some embodiments, changing the deflection angle of light projected onto the one or more image sensors comprises the use of a rotational stage on which the one or more image sensors are mounted and a reflector comprising at least one axis of tilt. In some embodiments, the reflector comprises a dichroic mirror.

In some embodiments, changing the deflection angle of light projected onto the object to the one or more image sensors comprises the use of a polygon mirror, a micromirror array, an acousto-optic deflector, a liquid crystal element, a liquid crystal array, or any combination thereof.

In some embodiments, changing the deflection angle of light projected onto the one or more image sensors comprises the use of a tiltable objective lens to create a magnification gradient across a field-of-view of the one or more image sensors. In some embodiments, changing the deflection angle of light projected onto the one or more image sensors further comprises the use of a tiltable tube lens or a tiltable image sensor.

In some embodiments, the method further comprises: acquiring a first image from an area of the object within the specified image acquisition time using a first illumination light intensity; acquiring a second image from the area of the object within the specified image acquisition time using a second illumination light intensity that is different from the first illumination light intensity; and combining the first image and the second image to generate a combined image having a higher dynamic range than either the first image or the second image. In some embodiments, the first image and the second image are acquired using a same image sensor in two separate image acquisition steps within the specified image acquisition time. In some embodiments, the first image and the second image are acquired using different image sensors in a same image acquisition step within the image acquisition time. In some embodiments, the dynamic range of the combined image is at least 2×, 5×, 10×, 15×, or 20× higher than the dynamic range of the first or second images.

In some embodiments, the method further comprises acquiring a plurality of images from an area of the object within the specified image acquisition time, wherein each of the plurality of images is acquired using a different illumination condition. In some embodiments, the different illumination conditions comprise a different light intensity, a different illumination pattern, a different illumination wavelength, or any combination thereof. In some embodiments, the plurality of images is acquired using a plurality of image sensors in a same image acquisition step within the specified image acquisition time. In some embodiments, the plurality of images is acquired using a same image sensor in a plurality of different image acquisition steps within the specified image acquisition time. In some embodiments, the plurality of images is acquired using a same image sensor in a plurality of different image acquisition steps at different times.

In some embodiments, a time-dependence of changing the deflection angle of light projected onto the one or more image sensors is periodically or continuously adjusted to synchronize the change in angle with changes in the relative motion between the object and the one or more image sensors. In some embodiments, the time-dependence of changing the deflection angle of light projected onto the one or more optical sensors is periodically or continuously adjusted without the use of a feedback mechanism.

In some embodiments, the relative motion between the object and the one or more image sensors comprises rotational motion in a two-dimensional plane, and the images of the two or more areas of the object correspond to a circular segment of the object.

In some embodiments, the relative motion between the object and the one or more image sensors comprises a combination of linear and rotational motion in a two-dimensional plane, and the images of the two or more areas of the object correspond to a spiral segment of the object.

In some embodiments, the static image of the object comprises a fluorescence image. In some embodiments, the object comprises a substrate, wafer, or flow cell for nucleic acid sequencing.

Disclosed herein are methods for imaging comprising: changing a deflection angle of light relayed within an imaging system and projected onto one or more image sensors using at least one optical component having a time-dependent orientation to correct for relative motion between a substrate to be imaged and the one or more image sensors, wherein the change in deflection angle results in formation of a static image of the substrate on the one or more image sensors for a specified image acquisition time. In some embodiments, the substrate comprises a rotating wafer. In some embodiments, the substrate comprises a plurality of nucleic acid sequencing colonies attached to at least one surface of the substrate. In some embodiments, the nucleic acid sequencing colonies comprise beads that are attached to the at least one surface of the substrate. In some embodiments, the image comprises a fluorescent image. In some embodiments, the method is used to perform nucleic acid sequencing.

Disclosed herein are systems comprising: a detection unit comprising one or more optical components and one or more optical sensors that are optically coupled to an object; and a counter-scan unit configured to change a deflection angle of light relayed within the counter-scan unit and projected onto the one or more optical sensors using at least one optical component having a time-dependent orientation to correct for relative motion between the object and the one or more optical sensors, thereby delivering a motion-invariant optical signal to the one or more optical sensors for a specified signal acquisition time. In some embodiments, the system further comprises an illumination unit comprising a radiation source and one or more optical components configured to project illumination light onto the object.

In some embodiments, the light projected onto the one or more optical sensors comprises light that is transmitted, reflected, or emitted by the object.

In some embodiments, illumination light is projected onto an area of the object that is greater than or equal to an area of a field-of-view of the one or more optical sensors for the specified signal acquisition time. In some embodiments, an angle of illumination light projected onto the object is changed using at least one optical component having a time-dependent orientation to correct for relative motion between the object and a light source that provides the illumination light.

In some embodiments, the illumination unit and the detection unit comprise different objective lenses. In some embodiments, the illumination unit and the detection unit comprise a common objective lens.

In some embodiments, the system comprises a first counter-scan unit for changing the angle of illumination light projected onto the object, and a second counter-scan unit for changing the deflection angle of light projected onto the one or more optical sensors.

In some embodiments, the illumination light projected onto the object comprises an area of substantially uniform light intensity.

In some embodiments, the radiation source comprises a laser. In some embodiments, the laser comprises a pulsed laser that is synchronized with signal acquisition.

In some embodiments, the illumination light projected onto the object comprises structured illumination.

In some embodiments, the counter-scan unit is configured to repeat changing the deflection angle of light projected onto the one or more optical sensors for two or more signal acquisition cycles, each cycle comprising a signal acquisition step and a rewind step, to acquire optical signals corresponding to two or more areas of the object. In some embodiments, the two or more areas are contiguous.

In some embodiments, the one or more optical sensors have a same field-of-view. In some embodiments, the one or more optical sensors have different fields-of-view.

In some embodiments, the relative motion between the object and the one or more optical sensors comprises linear motion, rotational motion, or any combination thereof within a two-dimensional plane. In some embodiments, the relative motion between the object and the one or more optical sensors comprises rotational motion within a two-dimensional plane.

In some embodiments, the counter-scan unit comprises two or more galvo-mirrors configured to change the deflection angle of light projected onto the one or more optical sensors. In some embodiments, the two or more galvo-mirrors are positioned between an objective lens and a tube lens used to relay the optical signal to the one or more optical sensors. In some embodiments, the two or more galvo-mirrors are positioned between a tube lens used to relay the optical signal and the one or more optical sensors. In some embodiments, each of the two or more galvo-mirrors have two tilt axes, and at least one of the two tilt axes is perpendicular to a two-dimensional plane within which the relative motion between the object and the one or more optical sensors occurs.

In some embodiments, the counter-scan unit comprises a rotational stage on which the one or more optical sensors are mounted and a reflector comprising at least one axis of tilt. In some embodiments, the reflector comprises a dichroic mirror.

In some embodiments, the counter-scan unit comprises a polygon mirror, a micromirror array, an acousto-optic deflector, a liquid crystal element, a liquid crystal array, or any combination thereof.

In some embodiments, the counter-scan unit comprises a tiltable objective lens configured to create a magnification gradient across a field-of-view of the one or more optical sensors. In some embodiments, the counter-scan unit further comprises a tiltable tube lens or a tiltable optical sensor that are collectively configured to create a magnification gradient across a field-of-view of the one or more optical sensors.

In some embodiments, the system is configured to: acquire a first optical signal within the specified signal acquisition time using a first illumination light intensity; acquire a second optical signal within the specified signal acquisition time using a second illumination light intensity that is different from the first illumination light intensity; and combine the first optical and the second optical to generate a combined optical signal having a higher dynamic range that the first optical signal or the second optical signal. In some embodiments, the dynamic range of the combined optical signal is at least 2×, 5×, 10×, 15×, or 20× higher than the dynamic range of the first or second optical signals.

In some embodiments, a time-dependence for changing the deflection angle of light projected onto the one or more optical sensors is periodically or continuously adjusted to synchronize the change in angle with changes in the relative motion between the object and the one or more optical sensors. In some embodiments, the time-dependence of changing the deflection angle of light projected onto the one or more optical sensors is periodically or continuously adjusted without the use of a feedback mechanism.

In some embodiments, the relative motion between the object and the one or more optical sensors comprises rotational motion in a two-dimensional plane, and the two or more acquired optical signals correspond to a circular segment of the object.

In some embodiments, the relative motion between the object and the one or more optical sensors comprises a combination of linear and rotational motion in a two-dimensional plane, and the two or more acquired optical signals correspond to a spiral segment of the object.

In some embodiments, the optical signal comprises a fluorescence signal.

In some embodiments, the one or more optical sensors comprise one or more image sensors, and the motion-invariant delivery of the optical signal to the one or more image sensors forms a static image on the one or more image sensors for a specified image acquisition period.

In some embodiments, the object to be imaged comprises a substrate, wafer, or flow cell for nucleic acid sequencing.

Also disclosed herein are systems comprising: a detection unit comprising one or more optical components and one or more image sensors that are optically coupled to a substrate to be imaged; and a counter-scan unit configured to change a deflection angle of light relayed within the counter-scan unit and projected onto the one or more image sensors using at least one optical component having a time-dependent orientation to correct for relative motion between the substrate and the one or more image sensors, thereby forming a static image on the one or more image sensors for a specified image acquisition time. In some embodiments, the substrate comprises a rotating wafer. In some embodiments, the substrate comprises a plurality of nucleic acid sequencing colonies attached to at least one surface of the substrate. In some embodiments, the nucleic acid sequencing colonies comprise beads that are attached to the at least one surface of the substrate. In some embodiments, the image comprises a fluorescent image. In some embodiments, the system is used to perform nucleic acid sequencing.

Disclosed herein are non-transitory computer-readable storage media storing one or more programs, the one or more programs comprising instructions which, when executed by one or more processors of a system, cause the system to perform any of the methods described herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

Various aspects of the disclosed methods, devices, and systems are set forth with particularity in the appended claims. A better understanding of the features and advantages of the disclosed methods, devices, and systems will be obtained by reference to the following detailed description of illustrative embodiments and the accompanying drawings, of which:

FIG. 1 provides a non-limiting schematic illustration of a scan step comprising an acquisition phase and a rewind phase as performed by a CAMS optical detection system comprising a counter scan subsystem in one embodiment described herein.

FIG. 2 provides a non-limiting schematic illustration of a duty cycle for a CAMS optical detection system comprising a counter scan subsystem in one embodiment described herein.

FIG. 3 provides a non-limiting schematic illustration of a CAMS optical detection system comprising a counter-scan subsystem that utilizes three galvanometer-controlled mirrors (“galvo-mirrors”) for redirecting light in one embodiment described herein.

FIG. 4 provides a non-limiting schematic illustration of a CAMS optical detection system comprising a counter-scan subsystem that utilizes a rotating camera and an actuator-controlled dichroic mirror for redirecting light in one embodiment described herein.

FIG. 5 provides a non-limiting schematic illustration of a CAMS optical detection system comprising a multiple camera configuration according to one embodiment described herein.

FIG. 6 provides a non-limiting schematic illustration of a computing device in accordance with one or more examples of the disclosure.

FIG. 7A provides a non-limiting schematic illustration of TDI line scanning.

FIG. 7B provides a non-limiting schematic illustration of area mode scanning.

FIG. 8A provides a non-limiting schematic illustration of a rotating wafer and the relative speed between a stationary optical sensor and the wafer as a function of radius.

FIG. 8B provides a non-limiting example of a plot of calculated smearing of optical signals detected by a stationary optical sensor (in the absence of counter-scanning) as a function of radial position relative to a rotating wafer from which the signals arise.

FIG. 8C provides a non-limiting example of a plot of calculated local smearing of an optical signal detected by a stationary optical sensor (in the absence of counter-scanning) as a function of radial position relative to a rotating wafer from which the signal arises.

FIG. 9A provides a non-limiting schematic illustration of a CAMS optical detection system comprising a counter-scan subsystem that utilizes two galvo-mirrors for redirecting light in one embodiment described herein.

FIG. 9B provides a non-limiting schematic illustration of the projection of five field points aligned with the x axis onto the image plane by a CAMS system in one embodiment described herein.

FIG. 9C provides a non-limiting schematic illustration of the projection of the five field points illustrated in FIG. 9B after rotating galvo-mirror M1 shown in FIG. 9A.

FIG. 9D provides a non-limiting schematic illustration of the projection of the five field points illustrated in FIG. 9B after rotating both galvo-mirrors M1 and M2 in FIG. 9A.

FIG. 9E illustrates a non-limiting exemplary proof of concept of the schematics depicted in FIGS. 9B, 9C, and 9D.

FIG. 10A provides a non-limiting schematic illustration of a rotating wafer and a calculation of the differences in magnification required to compensate for relative motion between the wafer and an optical detection system.

FIG. 10B provides a non-limiting schematic illustration of an optical design comprising a tilted objective lens and a tilted camera that may be used to achieve a gradient of magnification across the width of a field-of-view of an optical detection system.

FIG. 10C provides a non-limiting schematic illustration of an optical design comprising a tilted objective lens, a tilted tube lens, and/or a tilted camera to achieve a gradient of magnification across the width of a field-of-view of an optical detection system.

FIG. 10D provides a non-limiting example of a plot of calculated magnification at the image plane of the optical detection system versus working distance displacement.

FIG. 10E provides a non-limiting example of a plot of calculated magnification at the image plane of the optical detection system versus working distance displacement after reducing the distance between the objective and tube lens by 50 mm compared to that used for the calculated results shown in FIGS. 10D.

### DETAILED DESCRIPTION

Disclosed herein are methods and systems for performing continuous optical data collection (scanning) using area mode optical systems and an approach termed Counter-scan Area Mode Strobe (CAMS) that corrects for arbitrary combinations of linear and/or rotational relative motion between the object of interest and the optical detection system.

In the disclosed methods and systems, the CAMS optical detection system includes a counter-scan subsystem comprising at least one component that has time-dependent optical properties and is synchronized with the relative motion between the object and the detection system to correct for motion-induced smearing or blurring. In some instances, the counter-scan subsystem may be designed to redirect light transmitted, reflected, or emitted (e.g., output) by an object onto one or more optical sensors in a time-dependent manner such that a substantially motion-invariant optical signal is delivered to the one or more optical sensors for a specified signal acquisition time. In some instances, the counter-scan subsystem may be designed to redirect light transmitted, reflected, or emitted (e.g., output) by an object onto one or more image sensors in a time-dependent manner such that an image of the object on the one or more image sensors is substantially static for a specified image acquisition time. In some instances, the counter-scan subsystem may be designed to synchronously scan both an illumination light field (e.g., uniform illumination, structured illumination, or other illumination methods known in the art) projected onto the object and the light collected from the object and redirected to the one or more optical sensors (e.g., one or more image sensors) to maintain delivery of a substantially motion-invariant signal to the one or more optical sensors (e.g., to form a substantially static image on the one or more image sensors).

The advantages of the disclosed methods and systems may include: i) higher throughput data collection rates (e.g., in terms of either data rate (bits per second) or pixel read-out rate (pixels per second)), ii) higher throughput imaging at a given field-of-view, iii) compensation for both linear and rotational relative motion, or an arbitrary combination thereof, between the object of interest and the optical detection system, iv) more accurate compensation for relative motion than can be achieved using a comparable TDI line scanning system (thus enabling use of longer signal integration times and/or reducing smearing or blurring of optical signals), v) providing higher fill factors than a TDI camera-based detection system for the field-of-view of a typical imaging optical imaging system, vi) lower optical detection system costs, or any combination thereof.

In some instances, for example, the disclosed methods may comprise redirecting light output by an object onto one or more optical sensors in a time-dependent manner to correct for relative motion between the object and the one or more optical sensors, wherein an area of the object from which the light arises corresponds to a field-of-view for the one or more optical sensors, and wherein the time-dependent redirecting of the output light results in a substantially motion-invariant delivery of an optical signal to the one or more optical sensors for a specified signal acquisition time.

In some instances, the disclosed methods may comprise redirecting light output by an object to be imaged onto one or more image sensors in a time-dependent manner to correct for relative motion between the object and the one or more image sensors, wherein an area of the object from which the light arises corresponds to a field-of-view for the one or more image sensors, and wherein the time-dependent redirecting of the output light forms a substantially static image of the object on the one or more image sensors for a specified image acquisition time.

In some instances, the disclosed systems may comprise an illumination unit comprising one or more optical components and a radiation source configured to provide illumination that is optically coupled to an object; a detection unit comprising one or more optical components and one or more optical sensors that are optically coupled to the object and configured to detect light output by the object in response to illumination, wherein an area of the object from which the light arises corresponds to a field-of-view for the one or more optical sensors; and a counter-scan unit configured to redirect the light output by the object to the one or more optical sensors in a time-dependent manner to correct for relative motion between the object and the one or more optical sensors, thereby delivering a substantially motion-invariant optical signal to the one or more optical sensors for a specified signal acquisition time.

In some instances, the disclosed systems may comprise an illumination unit comprising one or more optical components and a radiation source configured to provide illumination that is optically coupled to an object; a detection unit comprising one or more optical components and one or more image sensors that are optically coupled to the object and configured to detect light output by the object in response to illumination, wherein an area of the object from which the light arises corresponds to a field-of-view for the one or more image sensors; and a counter-scan unit configured to redirect the light output by the object to the one or more image sensors in a time-dependent manner to correct for relative motion between the object and the one or more image sensors, thereby delivering a substantially static image of the object to the one or more image sensors for a specified image acquisition time.

The description is presented to enable one of ordinary skill in the art to make and use the invention and is provided in the context of a patent application and its requirements. Various modifications to the described embodiments will be readily apparent to those of skill in the art, and the generic principles described herein may be applied to other embodiments. Thus, the present invention is not intended to be limited to the embodiment(s) shown but is to be accorded the widest scope consistent with the principles and features described herein.

### Definitions

Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly indicates otherwise. Any reference to “or” herein is intended to encompass “and/or” unless otherwise stated and encompasses any and all possible combinations of one or more of the associated listed items.

As used herein, the terms “includes, “including,” “comprises,” and/or “comprising” specify the presence of stated features, integers, steps, operations, elements, components, and/or units but do not preclude the presence or addition of one or more other features, integers, steps, operations, elements, components, units, and/or groups thereof.

Throughout this application, various parameter values may be presented in a range format. It should be understood that the description in range format is merely for convenience and brevity and should not be construed as an inflexible limitation on the scope of the disclosure. Accordingly, the description of a range should be considered to have specifically disclosed all possible subranges as well as individual numerical values within that range, irrespective of whether a specific numerical value or specific sub-range is expressly stated. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 1.4, 2, 3, 3.6, 4, 5, 5.8, and 6. This applies regardless of the breadth of the range.

Numbers may be expressed herein as being “about” a particular value. Similarly, ranges may be expressed herein as from “about” one particular value and/or to “about” another particular value. The terms “about” and “approximately” shall generally mean an acceptable degree of error or variation for a given value or range of values, such as, for example, a degree of error or variation that is within 20 percent (%), 15%, 10%, or 5% of a given value or range of values.

As used herein the phrase “substantially motion-invariant” as applied to an optical signal collected by an optical detection system designed to correct for relative motion between an object of interest and the detection system refers to an optical signal that is invariant or that comprises less than a 5%, 4%, 3%, 2%, 1%, 0.5%, or 0.1% motion-induced change in optical signal magnitude (e.g., intensity) in a specified signal acquisition time period.

As used herein, the phrase “substantially static” as applied to an optical image acquired using an optical imaging system designed to correct for relative motion between an object to be imaged and the imaging system refers to an optical image that is static or that comprises less than 10, 8, 6, 4, 2, 1, 0.8, 0.6, 0.4, 0.2, or 0.1 pixels of smear.

As used herein, the phrase “component X is ‘optically coupled to’ component Y” generally specifies that component X is configured to emit, transmit, reflect, or otherwise output light, and component Y is configured to receive said light. For example, component X may comprise a radiation source that emits illumination light and component Y may comprise an objective. As another example, component X may comprise an objective and component Y may comprise an object to be imaged. Additional other component pairs may comprise different optical components from X and Y, as will be well understood by one of skill in the art.

It should be recognized that use of ordinal terms such as “first” and “second” in the description of methods and systems disclosed herein does not by itself connote any priority, order of importance of one system component over another, or the temporal order in which acts of a method are performed, but are used merely as labels to distinguish, for example, one system component having a certain name from another system component having the same name but for the use of the ordinal term to distinguish the two system components.

Additionally, various implementations of the methods and systems set forth herein may be described in terms of exemplary block diagrams, process flow charts, and other illustrations. As will become apparent to one of ordinary skill in the art after reading this document, the various implementations set forth herein can be implemented without confinement to the illustrated examples. For example, block diagrams and their accompanying description should not be construed as mandating a particular architecture or configuration. Similarly, in exemplary process flow charts, some blocks are optionally combined, the order of some blocks is optionally changed, and some blocks are optionally omitted. In some implementations, additional steps may be performed in combination with the exemplary processes. Accordingly, the methods and systems described and illustrated in greater detail below are exemplary by nature and, as such, should not be viewed as limiting.

The section headings used herein are for organizational purposes only and are not to be construed as limiting the subject matter described.

### I. Methods for Performing Counter-Scan Area Mode Strobe (CAMS) Optical Signal Detection

As noted above, the disclosed CAMS methods for optical signal detection that correct for relative motion between an object of interest and the optical detection system during signal (and/or image) acquisition are based on the use of an optical detection system that comprises a counter-scan subsystem. In some implementations, for example, it is the time-dependent orientation of at least one optical component (e.g., a galvo-mirror) in the counter-scan sub-system that leads to a time-dependent change in a deflection angle of light arising from a given location on the moving object and relayed within the optical detection system, which in turn leads to projection of a motion-invariant optical signal onto one or more optical sensor(s) of the optical detection system (e.g., the position of a field-of-view of the one or more optical sensors remains fixed with respect to the moving object over a specified signal acquisition time).

In some instances, the counter-scan subsystem is configured to redirect light output by the object to one or more optical sensors in a time-dependent manner, where an area of the object from which the light arises corresponds to a field-of-view for the one or more optical sensors (e.g., the area of the object that corresponds to a solid angle over which the one or more optical sensors are sensitive to the output light), and where the time-dependent redirection of the output light results in a substantially motion-invariant delivery of an optical signal (e.g., light intensity) to the one or more optical sensors for a specified signal acquisition time. As a result of the synchronization between the time-dependent redirection of the output light and the relative motion between the object and the optical detection system, the disclosed methods enable prevention and/or correction of motion-induced changes in acquired optical signals that would otherwise arise due to arbitrary combinations of linear and/or rotational relative motion in a two-dimensional object (or sample) plane within which the relative motion of the object and detection system occurs.

In some instances, the counter-scan subsystem is configured to redirect light output by an object to be imaged onto one or more image sensors in a time-dependent manner, where an area of the object from which the light arises corresponds to a field-of-view for the one or more image sensors, and where the time-dependent redirection of the light forms a substantially static image of the object on the one or more image sensors for a specified image acquisition time. As a result of the synchronization between the time-dependent redirection of the light output from the object and the relative motion between the object and the optical imaging system, the disclosed methods enable prevention and/or correction of motion-induced smearing or blurring in acquired optical images that would otherwise occur due to arbitrary combinations of linear and/or rotational relative motion in a two-dimensional object (or sample) plane within which relative motion between the object and detection system occurs.

In some instances, the counter-scan subsystem may comprise at least one component having time-dependent optical properties that are synchronized with the relative motion between the object and the optical detection system. Examples of counter-scan subsystem configurations for implementing the time-dependent redirection of the light output from the object include, but are not limited to, galvanometer-controlled mirrors (“galvo-mirrors”), actuator-controlled mirrors (e.g., actuator-controlled dichroic mirrors), micromirror arrays (or other MEMS devices), polygon mirrors, acousto-optic deflectors, liquid crystal elements, liquid crystal arrays, or any combination thereof, as will be described in more detail below.

More generally, the counter-scan subsystem can include at least one optical element that allows for a controllable deflection (e.g., a change of angle), a controllable shift (e.g., a lateral shift in position), a controllable change of polarization, or a controllable change of another property of light output by the object (e.g., light that is subsequently projected onto the sensors), so that the resulting patterns of light formed in the detector plane of the optical detection system are continuously shifted in space so as to counteract the shifts resulting from the relative motion of the object at each moment in time during a defined period of time. That is, the resulting patterns of light formed in the detector plane comprise a substantially motion-invariant optical signal.

In some instances, the counter-scan subsystem may operate in cycles referred to herein as scan steps. Each scan step may include one or more signal acquisition phases (during which the light output by a set of locations within or on the object is continuously projected onto a corresponding set of locations at the one or more optical sensors, and the resulting optical signals (e.g., light intensities) are electronically recorded) and a rewind phase (during which the mechanism used to redirect the light is returned to its original position). In some instances, the motion of the object relative to the optical detection system (or vice versa) may be continuous over a series of scan steps. In some instances, one or more series of scan steps may be performed until all areas of interest on or within the object have been scanned.

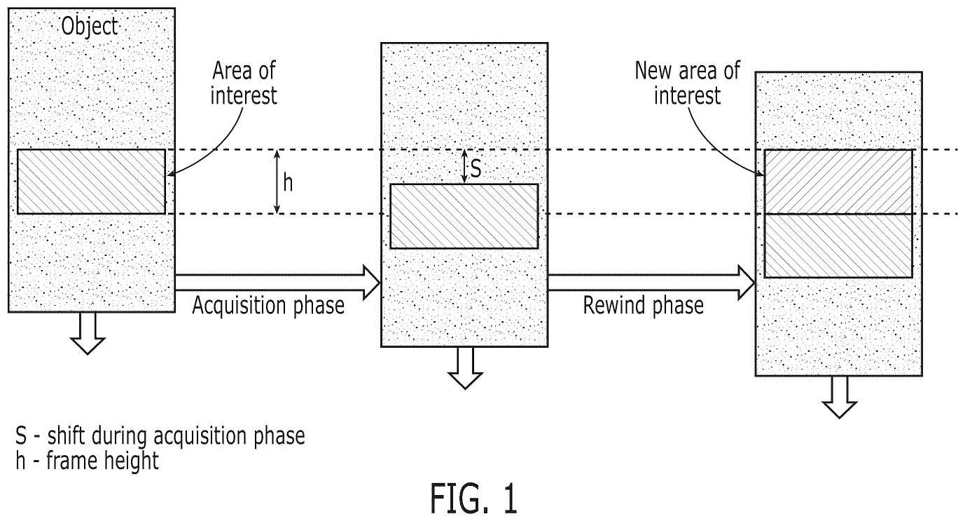

FIG. 1 provides a non-limiting schematic illustration of a scan step operation comprising a single acquisition phase and a rewind phase as performed by a CAMS optical detection system comprising a counter-scan subsystem. The relative motion between the object and the optical detection system is continuous for a defined period of time that is greater than or equal to the sum of the times required to perform a series of scan steps. Each scan step comprises an acquisition phase (e.g., a single acquisition phase as illustrated in the non-limiting example of FIG. 1) during which the mechanism (e.g., a galvo-mirror) used to redirect light output by the object (or an area of the object) is actuated (e.g., the galvo mirror is rotated with an angular velocity that is related to the linear velocity of the object) so as to present a static optical signal (e.g., a static image of an area of the object) to the optical sensor (e.g., an image sensor). In the rewind phase of the scan step, the mechanism used to redirect light (e.g., the galvo mirror) is returned to its original position. In FIG. 1, s is the positional shift of the area of the object from which signal is collected during the acquisition phase (the relative motion of the object is in the downward direction in FIG. 1), and h is the frame height (e.g., the dimension of the area of the object corresponding to the field-of-view of the optical sensor in a direction parallel to the relative motion). Depending on the type of optical sensor used, the rewind phase (i.e., the time during which the redirecting mechanism (e.g., the galvo mirror) is returned to its original position) can be used, if necessary, to read out the light-induced electrical signals from the optical sensor. For some optical sensors, the electrical signals can be read out during the acquisition of the next frame.

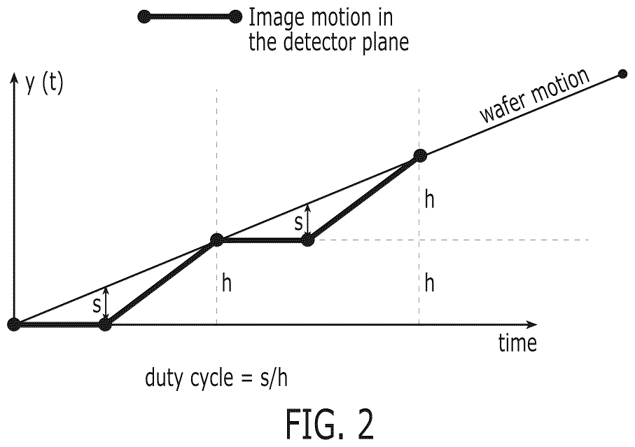

FIG. 2 provides a non-limiting schematic illustration of a duty cycle for a CAMS optical detection system (e.g., an optical imaging system) comprising a counter scan subsystem. The figure shows a plot of the y-coordinate (in the direction of relative motion between the object and the imaging system) of the area of the object to be imaged as a function of time over a time period in which the relative motion is continuous and two scan steps are performed. The heavy line indicates the motion of the area to be imaged in the detector (image) plane. During the acquisition phase, the area of the object to be imaged remains static in the detector plane (i.e., there is no change in y(t), although the object has advanced by a positional shift of s). During the rewind phase, the light redirecting mechanism is reset and the area of the object to be imaged is advanced in the detector plane by frame height h. The duty cycle for the scan step is thus given by the ratio of s/h.

In some instances, the CAMS methods disclosed herein may be applied generally to the acquisition of optical signals in applications where prevention of, correction of, or compensation for motion-induced changes to optical signals resulting from relative motion between an object of interest and an optical detection system is desired. In such instances, the CAMS system may comprise one or more optical sensors (e.g., photomultipliers, photodiodes, avalanche photodiodes, or photodiode arrays that are optionally operated in photon-counting mode; charge-coupled device (CCD) image sensors or cameras; CMOS image sensors or cameras; line scan cameras; TDI image sensors or cameras; or any combination thereof), and the optical signals acquired by the CAMS system may comprise, e.g., an intensity or a polarization of transmitted light, reflected light, emitted light (e.g., fluorescence light), or any combination thereof.

In some instances, the CAMS methods disclosed herein may be applied to the acquisition of optical images in applications where prevention of, correction of, or compensation for motion-induced smearing or blur of optical images resulting from relative motion between an object to be imaged and an optical imaging system is desired. In such instances, the CAMS system may comprise one or more image sensors (e.g., charge-coupled device (CCD) image sensors or cameras, CMOS image sensors or cameras, or any combination thereof), and the optical images acquired by the CAMS system may comprise, e.g., transmitted light images, reflected light images, emitted light images (e.g., fluorescence images), or any combination thereof. In some instances, the one or more image sensors may be used to acquire images in one or more different detection channels (e.g., one or more different fluorescence emission channels).

In some instances, an optical detection system configured to perform the CAMS methods disclosed herein may comprise one or more counter-scan subsystems (e.g., 1, 2, 3, or more than 3 counter-scan subsystems).

For example, in some instances, an optical detection system configured to perform the CAMS methods disclosed herein may comprise a counter-scan subsystem that is integrated with the optical path (comprising, for example, an objective lens, a tube lens, and one or more optical sensors (e.g., image sensors), etc.) used for signal acquisition (e.g., image acquisition). In such instances, illumination light may be provided by an illumination unit comprising a radiation source (e.g., a light source) and one or more optical components (e.g., lenses, prisms, mirrors, dichroic reflectors, etc.) configured to project a field-of-illumination on the object (or an area of the object) that is greater than or equal to, and overlaps with, an area of the object swept by the field-of-view for the one or more optical sensors over the specified signal acquisition time. In some instances, the illumination light is directed from the light source onto the object in a time-independent manner. In some instances, the illumination light is directed from the light source onto the object in a time-dependent manner. In some instances, the field-of-illumination projected on the object comprises an area of substantially uniform illumination light intensity. For example, if the field of illumination is approximately the same as the field-of-view, then the field-of-view is substantially uniformly illuminated. In some instances, the field-of-illumination projected on the object comprises an area of structured illumination. In some instances, optical signals (e.g., optical images) acquired using structured illumination may be used to construct, e.g., optical images having a higher spatial resolution than that inherent in the optical design of the optical detection system. In some instances, the light source comprises a laser (e.g., a continuous wave laser or a pulsed laser). In some instances, the laser comprises a pulsed laser that is synchronized with signal acquisition (e.g., a single laser pulse or a series of laser pulses may be synchronized with a signal acquisition period).

In some instances, an optical detection system configured to perform the CAMS methods disclosed herein may comprise two counter-scan subsystems, e.g., a first counter-scan subsystem that is integrated with the optical path (comprising, for example, an objective lens, a tube lens, and one or more optical sensors (e.g., image sensors), etc.) used for signal acquisition (e.g., image acquisition), and a second counter-scan subsystem that is integrated with the illumination optical path and synchronized with the first counter-scan subsystem so that both the delivery of illumination light and the redirection of light output from the object are performed in a time-dependent manner. In some instances, the field-of-illumination projected onto the object comprises an area of substantially uniform illumination light intensity. In some instances, the field-of-illumination projected on the object comprises an area of structured illumination. In some instances, optical signals (e.g., optical images) acquired using structured illumination may be used to construct, e.g., optical images having a higher spatial resolution than that inherent in the optical design of the optical detection system. In some instances, the light source comprises a laser (e.g., a continuous wave laser or a pulsed laser). In some instances, the laser comprises a pulsed laser that is synchronized with signal acquisition.

In some instances, two or more scan steps (e.g., 2, 3, 4, 5, 6, 7, 8, 9, 10, 20, 30, 40, 50, 60, 70, 80, 90, 100, or more than 100 scan steps) are performed, each scan step comprising one or more signal acquisition steps (e.g., 1, 2, 3, 4, or 5 signal acquisition steps) and a rewind step, thereby allowing acquisition of optical signals corresponding to two or more areas of the object (e.g., 2, 3, 4, 5, 6, 7, 8, 9, 10, 20, 30, 40, 50, 60, 70, 80, 90, 100, or more than 100 areas of the object). In some instances, the two or more areas of the object are contiguous. In some instances, the two or more areas of the object are not contiguous.

In some instances, the disclosed CAMS methods may further comprise acquiring a plurality of optical signals (e.g., optical images) from an area of the object within the specified signal acquisition time, wherein each of the plurality of optical signals is acquired using a different illumination condition. In some instances, the different illumination conditions may comprise, e.g., a different light intensity, a different illumination pattern, a different illumination wavelength, or any combination thereof. In some instances, the plurality of optical signals (e.g., optical images) is acquired using a plurality of optical sensors (e.g., optical image sensors) in a same signal acquisition step within a specified signal acquisition time. In some instances, the plurality of optical signals (e.g., optical images) is acquired using a same optical sensor (e.g., an optical image sensor) in a plurality of different signal acquisition steps within the same specified signal acquisition time. In some instances, the plurality of optical signals (e.g., optical images) is acquired using a same optical sensor (e.g., an optical image sensor) in a plurality of different signal acquisition steps at different times.

In some instances, the one or more optical sensors (e.g., image sensors) of the optical detection system have a same field-of-view. In some instances, the one or more optical sensors (e.g., image sensors) have different fields-of-view.

In some instances, the disclosed CAMS methods may enable prevention of, correction of, or compensation for motion-induced changes to optical signals arising from relative motion between the object and the one or more optical sensors of the optical detection system that comprises linear motion, rotational motion, or any combination thereof within a two-dimensional object (or sample) plane. In some instances, the relative motion between the object and the one or more optical sensors of the optical detection system comprises rotational motion in a two-dimensional plane, and the acquired optical signals correspond to two or more areas of the object that comprise a circular segment of the object. In some instances, the relative motion between the object and the one or more optical sensors of the optical detection system comprises a combination of linear and rotational motion in a two-dimensional plane, and the acquired optical signals correspond to two or more areas of the object that comprise a spiral segment of the object. In some instances, the relative motion between the object and the one or more optical sensors of the optical detection system comprises a combination of linear and rotational motion in a two-dimensional plane, and the acquired optical signals correspond to two or more areas of the object that comprise an arbitrary path mapped onto the object.

In some instances, the time-dependence of the redirection of the light output from the object is periodically or continuously adjusted to synchronize the redirection of the light with changes in the relative motion between the object and the one or more optical sensors.

In some instances, the substantially motion-invariant delivery of the optical signal(s) to one or more optical sensors is characterized in that it comprises less than a 5%, 4%, 3%, 2%, 1%, 0.5%, or 0.1% motion-induced change in optical signal in the specified signal acquisition time.

In some instances, e.g., where the one or more optical sensors comprise one or more image sensors, a substantially static image formed on an image sensor is characterized in that it comprises less than 0.1, 0.2, 0.4, 0.6, 0.8, 1, 2, 4, 6, 8, or 10 pixels of smear.

In some instances, various modifications of the disclosed CAMS methods (and corresponding CAMS systems) may optionally be implemented. For example, in some instances the CAMS method may comprise: (i) the use of structured illumination (as noted above) for acquiring optical images and constructing super-resolution images having a higher spatial resolution than that inherent in the optical design of the optical imaging system, (ii) the use of a scanned focused laser to illuminate the object, (iii) the use of non-scanned, wide-field illumination (e.g., an expanded laser beam, or a collimated beam from an arc lamp or tungsten halogen lamp) to illuminate the object, (iv) the use of a magnification gradient to compensate for relative motion between the object and the optical detection system (an approach that is applicable to both TDI line scanning systems and CAMS systems, as will be described in more detail below), v) the use of a multi-camera optical configuration, or vi) the use of a high dynamic range signal acquisition mode (e.g., a high dynamic range image acquisition mode).

### II. High Dynamic Range Optical Signal Acquisition Using CAMS

In some instances, two or more signal acquisition periods may be used to acquire signals from a same area of the object under different sets of conditions, e.g., different illumination conditions. For example, a first illumination pulse may be used to acquire a first image over a specified integration time, the image data from the camera is read, a second illumination pulse quickly follows, and the process repeats. The counter-scan subsystem can counter-scan (i.e., redirect light output from an object) either within each illumination pulse or for the time and/or distance between illumination pulses. In the latter case, the same exact area of the object is imaged twice. In the former case, the areas are staggered, and the image may be “stitched” or recomposed through image processing. In some instances, a dim image (i.e., the image acquired using a lower illumination intensity) may not include enough visible features for effective registration of the two images, so an advantage of the “exact repeat” approach (e.g., repetitive illumination pulses) is that registration may not be required at all, or a small registration window may suffice.

In some instances, the disclosed CAMS methods may thus comprise acquiring a first optical signal from the area of the object within the specified signal acquisition time using a first illumination light intensity; acquiring a second optical signal from the same area of the object within the specified signal acquisition time using a second illumination light intensity that is different from the first illumination light intensity; and combining the first optical signal and the second optical signal to generate a combined optical signal having a higher dynamic range that the first optical signal or the second optical signal. In some instances, the first optical signal and the second optical signal are acquired using a same optical sensor in two separate signal acquisition steps within the specified signal acquisition time. In some instances, the first optical signal and the second optical signal are acquired using different optical sensors in a same signal acquisition step within the signal acquisition time. In some instances, the dynamic range of the combined optical signal is at least 2×, 5×, 10×, 15×, or 20× higher than the dynamic range of the first or second optical signals.

In some instances, the combined optical signal may be composed of more than 2 optical signals, e.g., more than 2, 3, 4, 5, 6, 7, 8, 9, or 10 optical signals. In some instances, each optical signal used to form the combined optical signal is acquired using a respective illumination light intensity. In some instances, where the combined optical signal is obtained from a plurality of optical signals, at least a first optical signal in the plurality of optical signals is acquired using a first illumination light intensity and at least a second optical signal in the plurality of optical signals is acquired using a second illumination light intensity.

In some instances, e.g., when the one or more optical sensors comprise one or more image sensors, the disclosed CAMS methods may comprise acquiring a first optical image from the area of the object within the specified signal acquisition time using a first illumination light intensity; acquiring a second optical image from the area of the object within the specified signal acquisition time using a second illumination light intensity that is different from the first illumination light intensity; and combining the first optical image and the second optical image to generate a combined optical image having a higher dynamic range that the first optical image or the second optical image. In some instances, the first optical image and the second optical image are acquired using a same image sensor in two separate signal acquisition steps within the specified signal acquisition time. In some instances, the first optical image and the second optical image are acquired using different image sensors in a same signal acquisition step within the signal acquisition time. In some instances, the dynamic range of the combined optical image is at least 2×, 5×, 10×, 15×, or 20× higher than the dynamic range of the first or second optical images.

### II. Use of Magnification Gradients to Compensate for Relative Motion

In some instances, the methods disclosed herein may comprise an alternative approach to compensating for relative motion between an object (e.g., an object to be imaged) and an optical detection system (e.g., an optical imaging system). This alternative approach, referred to herein as “wedged counter-scanning”, may be achieved by creating a gradient of magnification across the field-of-view of an optical sensor (e.g., an image sensor).

The magnification gradient can give rise to a gradient in deflection angle of the collected light at one or more points within the optical system. In some instances, one or more tiltable optical component(s) may be used to create the magnification gradient, where the one or more tiltable optical component(s) are tilted in a time-dependent manner within a given signal acquisition period. In some instances, the orientation of the one or more tiltable optical component(s) used to create the magnification gradient may be static within a given signal acquisition period but may be changed in a continuous or stepwise time-dependent manner between different signal acquisition periods (e.g., when imaging segments of a wafer rotating about its center axis at different wafer radii). In some instances, different operating regimes may be used depending on the scanning pattern used. For example, if the scanning pattern (e.g., resulting from the relative motion between the object and an image sensor) is circular during a given image acquisition period, the magnification gradient (and orientation of the one or more tiltable optical components) may remain static during the image acquisition period and then subsequently adjusted. In another example, if the scanning pattern is spiral, the magnification gradient may be adjusted (e.g., the one or more tiltable optical components may be reoriented) in accordance with a change in radius of the scanned portion of the object.

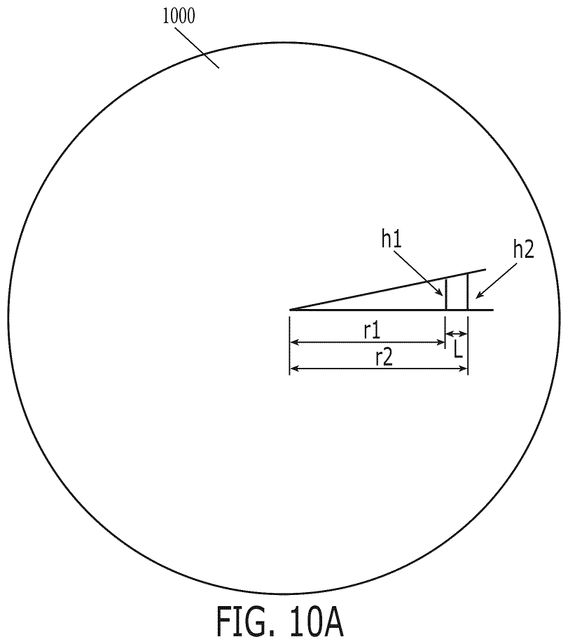

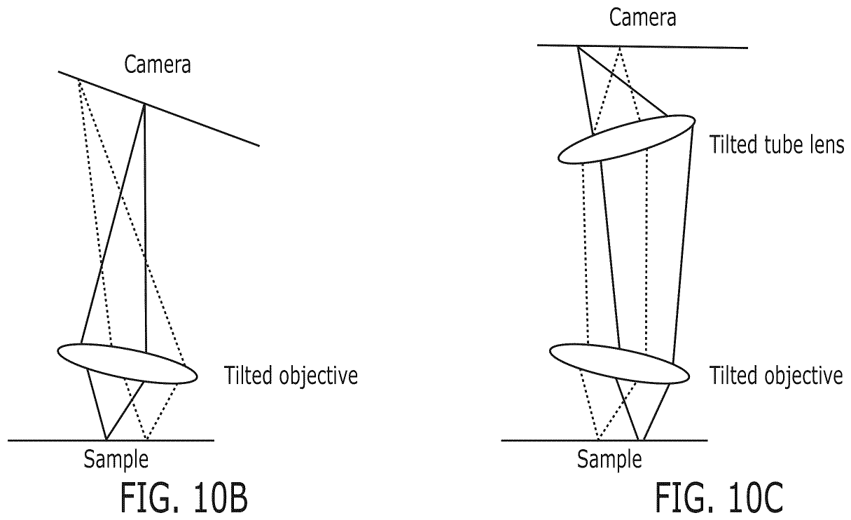

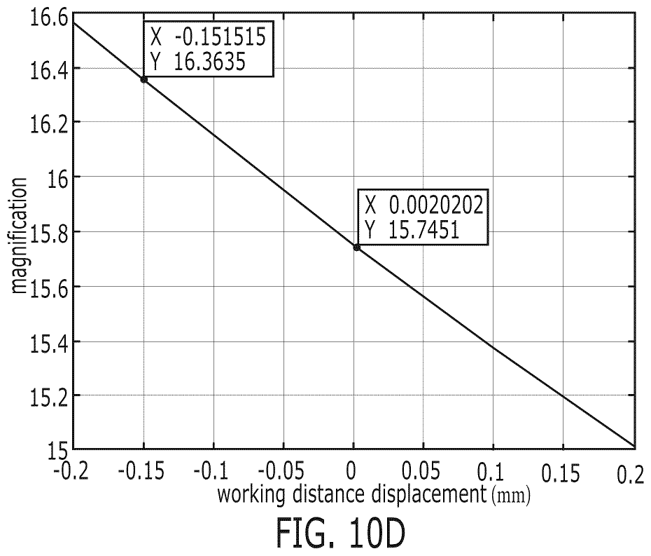

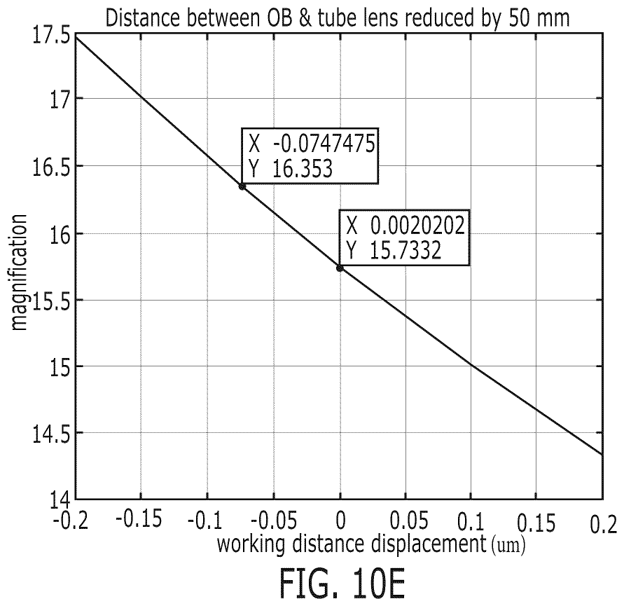

In the case that the relative motion between the object and the optical detection system comprises rotational motion centered about a rotational axis located outside the field-of-view of the optical detection system, the main technical challenge is caused by the fact that at radius r1 (corresponding to the innermost side of the image sensor) and at radius r2 (corresponding to the outermost side of the image sensor), the object to be imaged, e.g., a rotating wafer, moves by different distances (h1 and h2, respectively) during the image acquisition time (see FIG. 10A). One strategy for compensating for this relative motion is to separate the motion into linear (translational) and rotational motion components. An alternative strategy is to use wedged counter scanning where a magnification gradient can be created by, e.g., altering the working distance across the field-of-view of the image sensor. For example, a gradient of magnification characterized by a magnification ratio (i.e., the magnification at the outer radius of the sensor to the magnification at the inner radius of the sensor) given by Magnification Ratio=(h2/h1)=(r2/r1)=1+(L/r1) where L=r2−r1 could be used to compensate for the relative motion. In some instances, this same approach may be used to compensate for linear relative motion in a TDI line scanning system.

For an imaging system with a typical Scheimpflug layout (see FIG. 10B), different magnifications can be achieved at r1 and r2 by tilting the objective. A modem microscope is typically infinity corrected, includes both an objective and a tube lens, and is more-or-less telecentric (i.e., having a more-or-less constant magnification regardless of an object's distance or location in the field-of-view). In an exemplary microscope, the working distance must be increased or decreased by around 0.1 mm in order to achieve 2.5% change of magnification (see Example 5 below). In some instances, the distance between the objective and tube lens can be intentionally increased or decreased to break the telecentricity of the system and create a gradient of magnification across the field-of-view. As shown, one can achieve a 5% change of magnification across the field-of-view by using a reduced distance between the objective and tube lens and a 0.1 mm working distance displacement (see Example 5 below).

Accordingly, in some instances, the disclosed methods (e.g., methods for performing wedged counter-scanning) may comprise redirecting light output by the object to one or more optical sensors (e.g., image sensors) through the use of a tiltable objective lens configured to deliver the substantially motion-invariant optical signal to the one or more optical sensors (e.g., image sensors). In some instances, the redirecting of light output by the object to the one or more optical sensors further comprises the use of a tiltable tube lens and/or a tiltable image sensor. In some instances, tiltable objectives, tube lenses, and/or image sensors may be actuated using, e.g., piezoelectric actuators.

In some instances, the tilt angles for the objective, tube lens, and/or image sensor used to create a magnification gradient across the field-of-view may be different when the image sensor is positioned at a different distance (e.g., a different radius) from the axis of rotation.

In some instances, the tilt angles for the objective, tube lens, and/or image sensor may each range independently from about ±0.1 to about ±10 degrees. In some instances, the tilt angles for the objective, tube lens, and/or image sensor may each independently be at least ±0.1 degrees, ±0.2 degrees, ±0.4 degrees, ±0.6 degrees, ±0.8 degrees, ±1.0 degrees, ±2.0 degrees, ±3.0 degrees, ±4.0 degrees, ±5.0 degrees, ±6.0 degrees, ±7.0 degrees, ±8.0 degrees, ±9.0 degrees, or ±10.0 degrees. Those of skill in the art will recognize that, in some instances, the tilt angles for the objective, tube lens, and/or image sensor may independently have any value within this range of values, e.g., ±6.2 degrees.

In some instances, the nominal distance between the objective and tube lens may range from about 150 millimeters (mm) to about 250 mm. In some instances, the nominal distance between the objective and the tube lens may be at least 150 mm, 160 mm, 170 mm, 180 mm, 190 mm, 200 mm, 210 mm, 220 mm, 230 mm, 240 mm, or 250 mm. Those of skill in the art will recognize that, in some instances, the nominal distance between the objective and tube lens may have any value within this range of values, e.g., about 224 nm.

In some instances, the distance between the objective and tube lens may be increased or decreased from their nominal separation distance by at least about ±5 mm, ±10 mm, ±15 mm, ±20 mm, ±25 mm, ±30 mm, ±35 mm, ±40 mm, ±45 mm, ±50 mm, ±55 mm, ±60 mm, ±65 mm, ±70 mm, ±75 mm, or ±80 mm. Those of skill in the art will recognize that, in some instances, the distance between the objective and tube lens may be increased or decreased from their nominal separation distance by any value within this range of values, e.g., ±61 mm.

In some instances, the working distance may be increased or decreased by at least about ±0.01 mm, ±0.02 mm, ±0.03 mm, ±0.04 mm, ±0.05 mm, ±0.06 mm, ±0.07 mm, ±0.08 mm, ±0.09 mm, ±0.10 mm, ±0.20 mm, ±0.40 mm, ±0.60 mm, ±0.80 mm, ±1.00 mm, ±1.20 mm, ±1.40 mm, ±1.60 mm, ±1.80 mm, ±2.00 mm, ±2.20 mm., ±2.40 mm, ±2.60 mm, ±2.80 mm, or ±3.00 mm. Those of skill in the art will recognize that, in some instances, the working distance may be increased or decreased by any value within this range of values, e.g., ±1.09 mm.

In some instances, the change in magnification across the field-of-view may be at least about ±0.2%, ±0.4%, ±0.6%, ±0.8%, ±1.0%, ±1.2%, ±1.4%, ±1.6%, ±1.8%, ±2.0%, ±2.2%, ±2.4%, ±2.6%, ±2.8%, ±3.0%, ±3.2%, ±3.4%, ±3.6%, ±3.8%, ±4.0%, ±4.2%, ±4.4%, ±4.6%, ±4.8%, ±5.0%, ±5.2%, ±5.4%, ±5.6%, ±5.8%, or ±6.0%. Those of skill in the art will recognize that, in some instances, the change in magnification across the field-of-view may have any value within this range of values, e.g., ±4.01%.

### Iv. Systems for Performing Counter-Scan Area Mode Strobe (CAMS) Optical Signal Detection

Also disclosed herein are systems configured to perform any of the methods described. In general, the disclosed systems may comprise one or more illumination units (subsystems configured to deliver illumination and/or excitation light to an area of an object of interest), one or more detection units (subsystems configured to detect or image light transmitted, reflected or emitted by an area of an object of interest), one or more relative motion units (subsystems comprising, e.g., translation and/or rotation stages, and configured to provide relative motion between the object and the detection unit, or vice versa), and one or more counters-can units (subsystems configured to redirect light transmitted, reflected or emitted by an area of an object of interest in a time-dependent manner in order to correct for relative motion between the object and the optical detection system and thereby deliver a substantially time-invariant optical signal (or substantially static image) to one or more optical sensors (e.g., image sensors)). In some instances, all or a portion of the optical elements for a counter-scan subsystem may be integrated into the optical path of an illumination unit. In some instances, all or a portion of the optical elements for a counter-scan subsystem may be integrated into the optical path of a detection unit.

Illumination Unit: In some instances, an illumination unit may comprise one or more light sources (e.g., tungsten halogen lamps, arc lamps, flash lamps, strobe lamps, laser diodes, continuous wave lasers, pulsed lasers, or any combination thereof) and one or more additional optical elements (e.g., lenses, mirrors, prisms, beam-splitters, optical filters, colored glass filters, narrowband interference filters, broadband interference filters, dichroic reflectors, diffraction gratings, apertures, optical fibers, or optical waveguides, and the like). In some instances, an illumination unit may further comprise one or more shutters and/or acousto-optic modulators, e.g., to modulate the illumination light provided by a continuous light source such as an arc lamp or continuous wave laser.

The illumination unit may be configured to deliver illumination and/or excitation light to all or a portion of an object (e.g., an area within or on the surface of the object) located at an object plane (sample plane) of an optical detection system. In some instances, the illumination and/or excitation light may be continuous and of uniform intensity across the area being illuminated (e.g., the field-of-illumination). In some instances, the illumination and/or excitation light may be continuous and of non-uniform intensity across the area being illuminated (e.g., the illumination light may comprise a structured illumination pattern). In some instances, the illumination and/or excitation light may be discontinuous (e.g., pulsed) and of uniform or non-uniform intensity across the area being illuminated.

In some instances, the pulsed illumination provided by, e.g., a flash lamp, strobe lamp, or pulsed laser, may have a pulse duration of less than about 500 millisecond (ms), 100 ms, 50 ms, 10 ms, 5 ms, 1 ms, 500 microsecond (μs), 100 μs, 50 μs, 10 μs, 1 μs, 500 nanosecond (ns), 100 ns, 50 ns, 10 ns, or 1 ns. Those of skill in the art will recognize that in some instances the pulsed illumination may have a pulse duration of any value within this range, e.g., about 94 ms.

In some instances, a beam of light provided by a continuous wave or pulsed laser may be expanded to illuminate the area to be illuminated. In some instances, the illumination and/or excitation light may be provided by a pulsed laser, where the laser pulses are synchronized with the optical signal acquisition (or image acquisition) period. In some instances, the illumination and/or excitation light may be provided by a focused laser beam that is rapidly scanned (e.g., rastered) across the area to be illuminated on a timescale that is fast compared to the optical signal acquisition (or image acquisition) period.

In some instances, the area illuminated by a light source (e.g., the field of illumination) may be the same as the area of the object from which optical signals are collected or images are acquired. In some instances, the area illuminated by a light source may be larger than the area of the object from which optical signals are collected or images are acquired, e.g., 2×, 4×, 6×, 8×, 10×, 20×, 30×, 40×, 50×, 60×, 70×, 80×, 90×, or 100× larger. In some instances, wide-field, uniform illumination and/or excitation light may be provided by an illumination unit, where the resultant field-of-illumination is sufficiently larger than the area of the object from which optical signals are collected or images are acquired (i.e., larger in area than that swept by the area of the object from which optical signals are collected or images are acquired over the course of the signal (image) acquisition period) that no counter-scanning of the illumination and/or excitation light is required.

Detection Unit: In some instances, a detection unit may comprise one or more optical sensors (e.g., one or more image sensors), and one or more additional optical elements (e.g., objective lenses, other lenses, mirrors, prisms, beam-splitters, optical filters, colored glass filters, narrowband interference filters, broadband interference filters, dichroic reflectors, diffraction gratings, apertures, optical fibers, or optical waveguides, and the like). In some instances, a detection unit may further comprise one or more shutters and/or acousto-optic modulators, e.g., to modulate light output by an object prior to its reaching the one or more optical sensors.

The detection unit may be configured to collect light output by the object upon illumination and deliver it to the one or more optical sensors. In some instances, the detection unit may be configured to collect light output by the object upon illumination and form an image on one or more image sensors. In some instances, the one or more optical sensors may comprise, e.g., photomultipliers, photodiodes, avalanche photodiodes, or photodiode arrays that are optionally operated in photon-counting mode; charge-coupled device (CCD) image sensors or cameras; CMOS image sensors or cameras; line scan cameras; TDI image sensors or cameras; or any combination thereof. Image sensors may be monochrome image sensors (i.e., configured to capture greyscale images) or color image sensors (i.e., configured to capture RGB or color images).

In some instances, the detection unit may comprise one or more optical sensors that have the same field-of-view (e.g., the area of the object that corresponds to a solid angle over which the one or more optical sensors are sensitive to the light output by the object). In some instances, the detection unit may comprise one or more optical sensors that have different fields-of-view.

In some instances, the detection unit may be configured to detect optical signals (e.g., an intensity or polarization of transmitted, light, reflected light, emitted light (e.g., fluorescence), or any combination thereof). In some instances, the detection unit may be configured to acquire optical images (e.g., transmitted light images, reflected light images, emitted light images (e.g., fluorescence images), or any combination thereof).

Relative Motion Unit: As noted above, the relative motion subsystem is configured to provide relative motion between the object and the detection unit, or vice versa. Examples of typical subsystem components include, but are not limited to, linear actuators, X-Y translation stages, and/or rotation stages. Suitable translation stages are commercially available from a variety of vendors, for example, Parker Hannifin. Precision translation stage or rotation stage subsystems typically comprise a combination of several components including, but not limited to, linear actuators, optical encoders, servo and/or stepper motors, and motor controllers or drive units. High precision and repeatability of stage movement is preferred for the systems and methods described herein in order to ensure accurate and reproducible positioning and signal/image acquisition.

Counter-Scan Unit: As noted above, the counter-scan subsystem is configured to redirect light transmitted, reflected or emitted by an area of an object of interest in a time-dependent manner in order to correct for relative motion between the object and the optical detection system and thereby deliver a substantially time-invariant optical signal (or substantially static image) to one or more optical sensors (e.g., image sensors).

In some instances, the counter-scan subsystem may comprise one, two, three, four, or more than four galvo mirrors (as will be described in more detail below). In some instances, the counter-scan subsystem may comprise a rotational stage on which an image sensor is mounted, and a tiltable dichroic reflector actuated by, e.g., a piezoelectric actuator (as will also be described in more detail below). In some instances, the counter-scan subsystem may comprise a rotating polygon mirror. In some instances, the counter-scan subsystem may comprise a prism, an optical window (e.g., a plate made of a transparent optical material), or other optical element mounted in a device that enables controllable tilt or shift of the prism, optical window, or other optical element. In some instances, the counter-scan subsystem may comprise an acousto-optic deflector, a digital micromirror array (MMA) or other MEMS device, a liquid crystal element, or a liquid crystal array.

In some instances, all or a portion of the optical elements for a counter-scan subsystem may be integrated into the optical path of an illumination unit. In some instances, all or a portion of the optical elements for a counter-scan subsystem may be integrated into the optical path of a detection unit.

In some instances, the galvo-mirrors or other scan components of the counter-scan unit may be configured to redirect light output by the object to compensate for relative linear velocities ranging from about 0 mm/ms to about 20 mm/ms. In some instances, the galvo-mirrors or other scan components of the counter-scan unit may be configured to redirect light output by the object to compensate for relative linear velocities of at least 0.1 millimeters per millisecond (mm/ms), 0.5 mm/ms, 1 mm/ms, 2 mm/ms, 3 mm/ms, 4 mm/ms, 5 mm/ms, 6 mm/ms, 7 mm/ms, 8 mm/ms, 9 mm/ms, 10 mm/ms, 11 mm/ms, 12 mm/ms, 13 mm/ms, 14 mm/ms, 15 mm/ms, 16 mm/ms, 17 mm/ms, 18 mm/ms, 19 mm/ms, or 20 mm/ms. Any two values described in this paragraph may be combined to form a range included within the present disclosure, for example, in some instances the galvo-mirrors or other scan components of the counter-scan unit may be configured to redirect light output by the object to compensate for relative linear velocities of between 0.5 mm/ms and 12 mm/ms. Those of skill in the art will recognize that in some instances the galvo-mirrors or other scan components of the counter-scan unit may be configured to redirect light output by the object to compensate for relative linear velocities of any value within this range, e.g., about 10.4 mm/ms.

In some instances, the galvo-mirrors or other scan components of the counter-scan unit may be configured to redirect light output by the object to compensate for relative angular velocities ranging from about 0°/ms to about 10°/ms. In some instances, the galvo-mirrors or other scan components of the counter-scan unit may be configured to redirect light output by the object to compensate for relative angular velocities of at least 0.1 degrees per millisecond (°/ms), 0.5°/ms, 1°/ms, 2°/ms, 3°/ms, 4°/ms, 5°/ms, 6°/ms, 7°/ms, 8°/ms, 9°/ms, or 10°/ms. Any two values described in this paragraph may be combined to form a range included within the present disclosure, for example, in some instances the galvo-mirrors or other scan components of the counter-scan unit may be configured to redirect light output by the object to compensate for relative angular velocities of between 0.1°/ms and 7°/ms. Those of skill in the art will recognize that in some instances the galvo-mirrors or other scan components of the counter-scan unit may be configured to redirect light output by the object to compensate for relative angular velocities of any value within this range, e.g., about 0.8°/ms.

Exemplary CAMS System Configurations: One non-limiting example of a system configured to perform the CAMS method described herein (e.g., a CAMS system) comprises a microscope having an objective lens facing the object, and a tube lens that forms an image on an area mode optical sensor (e.g., an image sensor), as well as a subsystem (e.g., a translation and/or rotation stage) to enable the relative motion of the object relative to the optical system (or vice versa). The system also includes a counter-scanning subsystem comprising, e.g., a galvanometer-controlled scanning mirror (i.e., an optical mirror whose tilt can be controlled by an input electrical signal). In some instances, the galvo mirror may be positioned in the space between the objective lens and the tube lens of the microscope. In some instances, the galvo mirror may be positioned in the space between the tube lens and one or more optical sensors (e.g., image sensors). Within some range of angles (e.g., ±0.001°, ±0.01°, ±0.1, 0.5°, ±1.0°, ±5.0°, ±10.0°, ±15.0°, ±20.0°, or ±25.0°), a change of tilt of the galvo mirror positioned as described above leads to a shift of the image relative to the sensor and thus may be used to compensate for the relative motion between the object and the image sensor. A CAMS system comprising a single galvo mirror may be used to correct for linear relative motion between the object and image sensor in the two-dimensional sample plane of the detection unit. In some instances, the counter-scan subsystem may comprise one, two, three, or more than three galvo mirrors.

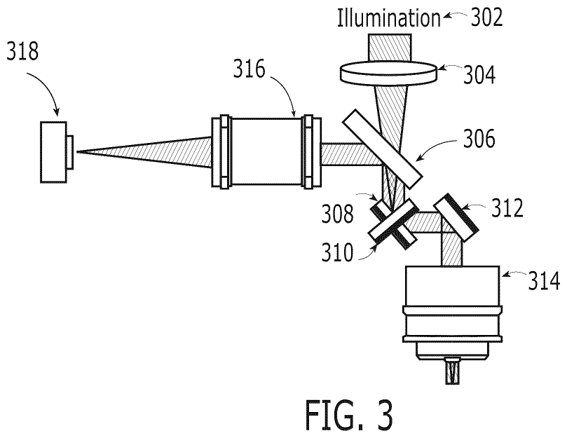

FIG. 3 provides a non-limiting schematic illustration of a more generally applicable CAMS optical detection system comprising a counter-scan subsystem that utilizes three galvo-mirrors for redirecting light. The CAMS system illustrated in FIG. 3 is configured for use in, e.g., fluorescence imaging. Excitation light 302 (provided by a light source that is not shown in the figure) is directed by means of condenser lens 304 to dichroic mirror 306, where it is transmitted and directed to an object (not shown in the figure) via galvo mirrors 308, 310, 312, and objective 314. Fluorescence emitted by the object in response to illumination with excitation light 302 is collected by the objective 314 and transmitted via galvo mirrors 312, 310, 308 back to dichroic mirror 306, where it is reflected and imaged onto image sensor 318 by tube lens 316. Adjusting the tilt on galvo mirrors 308, 310, and 312 allows one to shift the image on the sensor in two dimensions. The use of three galvo mirrors for counter-scanning in this example enables correction for arbitrary combinations of linear and/or rotational relative motion between the object and image sensor in the two-dimensional sample plane of the detection unit.

Commercially available galvo mirrors (or galvo scanners) such as those illustrated schematically in FIG. 3 are fast and accurate. See, for example, the single axis scanning galvo systems available from Thorlabs (Newton, NJ) which can accommodate beam diameters of up to 20 mm maximum and provide scan angles of up to ±22.5 degrees, response times of about 0.65 ms with a repeatability of 10 microradian (μrad, i.e., less than 0.0006 degrees).

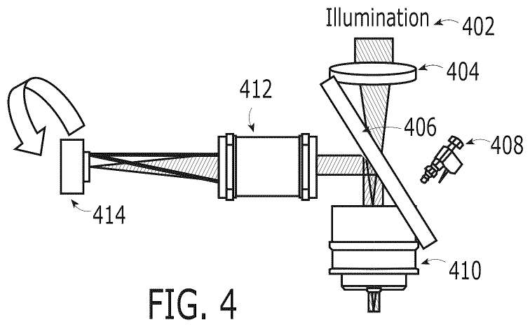

FIG. 4 provides an alternative configuration for a CAMS optical detection system, where the counter-scan subsystem comprises a rotational stage (not shown) on which the image sensor 414 is mounted, and a tiltable dichroic reflector 406 actuated by, e.g., a piezoelectric actuator 408. Excitation light 402 (provided by a light source that is not shown in the figure) is directed by means of condenser lens 404 to dichroic mirror 406, where it is transmitted and directed to an object (not shown in the figure) via objective 410. Fluorescence emitted by the object in response to illumination with excitation light 402 is collected by the objective 410 and transmitted back to dichroic mirror 406, where it is reflected and imaged onto image sensor 414 by tube lens 412. In this configuration, rotation of the image sensor 414 enables correction for rotational relative motion and tilting of dichroic mirror 406 enables correction for linear relative motion, thereby enabling correction for arbitrary combinations of linear and/or rotational relative motion between the object and image sensor in the two-dimensional sample plane of the detection unit.

One potential challenge with the approach illustrated in FIG. 4 is the need to find an actuator (e.g., a rotational stage) that can rotate the relatively heavy image sensor on a fast timescale (e.g., with rotational rates on the order of 400 Hz) and accurately (e.g., with repeatability of less than about 0.004 degrees).

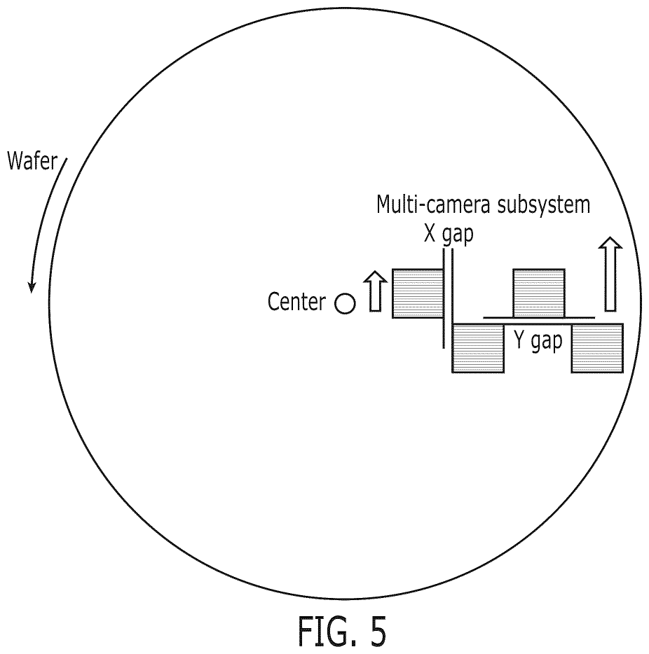

FIG. 5 provides a non-limiting schematic illustration of a CAMS optical detection system comprising a multiple camera configuration (i.e., comprising four cameras in this illustration). Dividing the field-of-view of the objective lens (e.g., a section of a rotating wafer) among several different cameras provides an option for overcoming the data-rate limitations of commercially available cameras. In some instances, the multiple camera (or image sensor) configuration may comprise the use of 2, 3, 4, 5, 6, 7, 8, 9, 10, or more than 10 different cameras (or image sensors).

In some instances, the respective fields-of-view for the different cameras may be contiguous. In some instances, the respective fields-of-view for the different cameras may overlap. In some instances, leaving gaps between the different cameras' respective fields-of-view (e.g., the “X gap” and “Y gap” illustrated in FIG. 5) may simplify the optical design required for splitting the field-of-view of the objective lens (e.g., simple mirrors may suffice). Gaps in the Y direction (i.e., the direction of rotational motion in the example shown in FIG. 5) can be accommodated by use of a scan step (comprising a signal acquisition phase and a rewind phase) that ensures signal or image acquisition from contiguous areas of the object in the Y direction). In some instances, gaps in the X direction (i.e., the radial direction in the example shown in FIG. 5) may be accommodated by alignment with corresponding patterns in, e.g., a surface of a wafer to be imaged.

Counter-scanning the light output by the object can be used to correct for the radius-dependent smearing of images (or other area mode optical signals) that would otherwise arise due to the different relative linear speeds at different radii. In some instances, a separate counter-scan subsystem may be used for each camera (i.e., especially where each camera is positioned at different radii). Alternatively, in some instances, a single shared counter-scan subsystem may be used for the entire field-of-view of the objective, irrespective of the number of cameras.

CAMS System Operation: As noted above, the counter-scan subsystem may be operated in cycles referred to herein as scan steps. Each scan step may include one or more signal acquisition phases (e.g., 1, 2, 3, 4, 5, or more than 5 signal acquisition phases during which electronic signals indicative of the light output by the object are acquired by an optical sensor) and a rewind phase (during which the counter-scan system used to redirect the light is returned to its original position). In some instances, the motion of the object relative to the optical detection system (or vice versa) may be continuous over a series of scan steps. In some instances, one or more scan steps (e.g., 2, 3, 4, 5, 6, 7, 8, 9, 10, 20, 30, 40, 50, 60, 70, 80, 90, 100, or more than 100 scan steps) may be performed until all areas of interest on or within the object have been scanned.

In many cases, the areas of the object addressed in successive scan steps are required to be contiguous. This can occur if the size of the optically surveyed area in the scan direction (i.e., the frame height) is equal to the shift in position of the object in each scan step (i.e., the step size).

The duty cycle of the counter-scan subsystem is the fraction of the time during a scan step when optical signals are collected (i.e., the ratio of the acquisition phase duration to the total scan step duration) and is generally less than one. As illustrated in FIG. 1, the duty cycle is equal to the ratio of the object shift occurring during the acquisition phase to the step size. A CAMS system can be designed with different duty cycles, e.g., ranging from about 0.001 to approaching unity. In some instances, the duty cycle of the CAMS system may be at least 0.001, 0.005, 0.01, 0.05, 0.1, 0.2, 0.3, 0.4, 0.5, 0.6, 0.7, 0.8, 0.9, 0.95, 0.98, or 0.99.

In a CAMS system, illumination needs to be active only during the acquisition phase of each scan step. In some instances, e.g., for a small duty cycle system, a pulsed illumination light source can be used (such as a pulsed laser or a flash lamp (stroboscopic illumination)). For a large duty cycle system, a continuous illumination light source (e.g., a continuous wave (CW) laser) can be used, optionally coupled with an appropriate gating mechanism such as a shutter.

At any given time during the acquisition phase of a scan step, the illumination light only needs to cover the area of the object that is being optically surveyed at that time. Therefore, in some configurations of a CAMS system, the illuminating light may be projected onto an area that is co-moving with the object (i.e., the illumination may be counter-scanned along with the light output by the object). In some instances, this can be achieved using the same counter-scan system that is used for redirecting the light output by the object. In some instances, a separate counter-scanned illumination subsystem may be used. In some instances, counter-scanned illumination may also be used to generate patterned illumination that is co-moving with the object, e.g., for optical scanning applications based on structured illumination microscopy. In addition, restricting the illumination to only the area of the object being surveyed leads to each area of the object being illuminated just once (e.g., to prevent double exposure and minimize fluorescence photo-bleaching). Finally, counter-scanned illumination can reduce the optical power required for illumination, especially in the case of large duty cycle CAMS systems (which enable the use of longer signal acquisition/integration times).

The disclosed CAMS systems can offer significant advantages relative to, e.g., a state-of-the-art TDI scanning system in terms of throughput attainable at a given field-of-view (FOV). Such a comparison can be made, for example, in terms of an equivalent line rate, which is equal to the maximal frame rate of an area mode sensor multiplied by the number of pixel rows in the sensor and indicates the number of pixel rows per second that a sensor can process. That equivalent line rate can be compared to the line rate of a TDI sensor. Consider the following examples:

For an area mode CMOS camera with an array size of 1280×864 pixels having a maximum frame rate of 3675 frames per second, the equivalent TDI line rate is 864×3675 Hz=3.17 MHz, which is well above the line rates attainable in state-of-the art TDI cameras.

For an area mode CMOS camera with an array size of 2176×4608 pixels having a maximum frame rate of 810 frames per second, the equivalent TDI line rate is 2176×810 Hz=1.76 MHz, which again is well above the pixel rate attainable in state-of-the art TDI cameras.

In some instances, the disclosed CAMS systems successfully compensate for relative motion between and object and a detection unit of the CAMS system to deliver substantially motion-invariant optical signals to one or more optical sensors. In some instances, substantially motion-invariant delivery of the optical signal(s) to one or more optical sensors is characterized in that it comprises less than a 5%, 4%, 3%, 2%, 1%, 0.5%, or 0.1% motion-induced change in optical signal in the specified signal acquisition time. Those of skill in the art will recognize that, in some instances, for the disclosed CAMS systems, motion-induced change in optical signal in the specified signal acquisition time may have any value within this range of values, e.g., about 1.12%.

In some instances, the disclosed CAMS systems successfully compensate for relative motion between an object and a detection unit of the CAMS system to form substantially static images on one or more image sensors. In some instances, a substantially static image formed on an image sensor (or sensors) is characterized in that it comprises less than 0.1, 0.2, 0.4, 0.6, 0.8, 1, 2, 4, 6, 8, or 10 pixels of smear. Those of skill in the art will recognize that, in some instances, the substantially static image may comprise smear of any value within this range of values, e.g., 2.2 pixels.

In some instances, this metric may be dependent upon parameters such as the sensor size, angular velocity, etc. For example, for a sensor having a number (L) of 8,000 pixels in the x (radial) dimension and a pixel dimension of 0.2 μm, the FOV in the x (radial) dimension is given by 8,000 pixels×0.2 μm/pixel=1.6 mm. That is, the effective length of the sensor is 1.6 mm. The counter rotational angle required to maintain a static image on the sensor is described by L/r/pi*180, where r is (r1+r2)/2. For a given time period (e.g., a given exposure time), the angular velocity of the sensor is L/r/pi*180/s μ, where s is a number of seconds (e.g., 50 microseconds (μs)) of exposure.

A major advantage of the disclosed CAMS systems relative to a TDI scanning system is that in TDI, the signals can only shift linearly along the detector plane, which only allows compensation for linear relative motion of the object. In contrast, a counter-scanning subsystem can be designed for a CAMS system to accommodate more complicated patterns of relative motion, e.g., combinations of linear motion and rotation of the object relative to the sensor. The greater flexibility of a CAMS system (e.g., as compared to a TDI system) allows for more accurate correction for relative motion and enables longer signal acquisition/integration times and/or reduces blurring. Longer signal acquisition/integration times also enable operation of CAMS systems at a high duty cycle (e.g., high throughput). In particular, longer signal acquisition/integration times enable higher signal-to-noise ratio in contexts where illumination intensity is limited by the object's sensitivity to illumination light, as is the case in fluorescence microscopy.

Additional CAMS System Components & Specifications: As noted above, systems configured to perform any of the methods described herein may comprise one or more illumination units, one or more detection units, one or more relative motion units, and one or more counters-can units. In some instances, the one or more illumination units, detection units, relative motion units, and counter-scan units may be designed and packaged as separate modules or subsystems of the CAMS system. In some instances, one or more illumination units, detection units, relative motion units, and/or counter-scan units may be designed and packaged as integrated modules or subsystems of the CAMS system. In some instances, all or a portion of an illumination unit and/or detection unit may comprise the use of a commercially available microscope.

In some instances, a system configured to implement the CAMS methods disclosed herein may further comprise one or more processors or system controllers (e.g., microprocessors or computers), one or more sample carriers or stages adapted to hold an object of interest, one or more fluidics modules, one or more temperature control modules, one or more additional translation and/or rotation stages, one or more system control software packages, one or more data analysis (e.g., image processing) software packages, or any combination thereof. As noted, in some instances, the CAMS system may comprise an integrated system, e.g., where the different functional subsystems are mounted on a single framework or chassis and packaged within a single housing. In some instances, the CAMS system may comprise a modular system, e.g., where the different functional subsystems are mounted on separate frameworks or chassis and packaged in separate housings. In some instances, the one or more processors or system controllers may interface with an external computer system.

Objective lenses: The detection units described herein, e.g., fluorescence imaging units, may comprise one or more objective lenses of the same type or of different types. Examples of suitable objective lenses include, but are not limited to, low magnification objectives (e.g., 5× and 10× objectives), intermediate magnification objectives (e.g., 20× and 50× objectives), high magnification objectives (e.g., 100× objectives), or long working distance objectives. In some instances, suitable objectives may include, but are not limited to, dry objectives, cover slip-corrected objectives, infinity-corrected objectives, achromatic objectives, plan achromatic objectives, fluorite (or semi-apochromatic) objectives, plan fluorite objectives, and plan apochromatic objectives. In some instances, the one or more objective lenses may comprise objectives of a custom design that exhibit a specified magnification (or magnification gradient across a field-of-view), numerical aperture, working distance, focal distance, etc., or any combination thereof.

In some instances, the one or more objective lenses may be fixed components of the detection unit or CAMS system. In some instances, the one or more objective lenses may be moveable (or replaceable) components of the detection unit or CAMS system, e.g., by mounting them on a rotatable turret, mounting them on a translatable slide or stage, etc. In some instances, the one or more objective lenses may comprise both fixed and moveable (or replaceable) components of the detection unit or CAMS system.

Tube lenses: In some instances, the detection unit or CAMS system may comprise one or more tube lenses, e.g., lenses positioned in the optical path between an objective lens and an optical sensor (e.g., an image sensor) to collimate and/or focus the light transmitted by the objective onto the optical sensor. In some instances, the one or more tube lenses may comprise fixed components of the detection unit or CAMS system. In some instances, the one or more tube lenses may be moveable (or replaceable) components of the detection unit or CAMS system, e.g., by mounting them on a rotating stage, mounting them on a translatable slide or stage, etc. In some instances, the one or more tube lenses may comprise both fixed and moveable (or replaceable) components of the detection unit or CAMS system.

Image sensors: In some instances, the detection unit or CAMS system may comprise one or more image sensors (or cameras) that may be the same or may be different and may include any of a variety of image sensors including, but not limited to, photodiode arrays, charge-coupled device (CCD) sensors or cameras, or complementary metal-oxide-semiconductor (CMOS) image sensors or cameras. In some instances, the one or more image sensors may comprise one-dimensional (linear) or two-dimensional pixel array sensors. In some instances, the one or more image sensors may comprise monochrome image sensors (e.g., configured to capture greyscale images) or color image sensors (e.g., configured to capture RGB or color images). In some instances, the one or more image sensors (or cameras) may comprise high framerate (fast readout rate) image sensors. For example, in some instances, the one or more image sensors may have a framerate of at least 200 frames per second (fps), 250 fps, 300 fps, 350 fps, 400 fps, 500 fps, 600 fps, 700 fps, 800 fps, 900 fps, or 1,000 fps. Those of skill in the art will recognize that, in some instances, the one or more image sensors may have a framerate may have any value within this range of values, e.g., about 725 fps.

Image acquisition mode: In some instances, the detection unit or CAMS system may be configured to acquire images in any of a variety of imaging modes. Examples include, but are not limited to, bright-field, dark-field, fluorescence, phase contrast, or differential interference contrast (DIC), and the like.

Light sources: In some instances, the illumination unit or CAMS system may comprise one or more light sources. Examples of light sources include, but are not limited to, tungsten lamps, tungsten-halogen lamps, arc lamps, flash lamps, strobe lamps, light emitting diodes (LEDs), laser diodes or lasers. In some instances, the one or more light sources may produce continuous wave, pulsed, Q-switched, chirped, frequency-modulated, and/or amplitude-modulated light at a specified wavelength (or within a specified wavelength band-pass) defined by the light source alone or in combination with one or more optical filters (e.g., one or more colored glass filters, narrowband interference filters, broadband interference filters, dichroic reflectors, diffraction gratings, etc.).

Structured illumination components: In some instances, the illumination unit or CAMS system may comprise one or more optical transformation elements configured to generate structured illumination (or patterned illumination). Examples of suitable optical transformation elements include, but are not limited to, diffraction gratings, grid masks, sinusoidal phase gratings, micro-lens arrays (MLAs), spatial light modulators, and the like.

Fluorescence excitation light wavelengths: In some instances, the CAMS system may be configured for fluorescence imaging, e.g., single channel fluorescence imaging or multichannel fluorescence imaging. In some instances, at least one of the one or more light sources of the illumination unit or CAMS system may produce visible light, such as blue light, green light and/or red light. In some instances, at least one light source, alone or in combination with one or more optical components, e.g., excitation optical filters and/or dichroic beam splitters, may produce fluorescence excitation light at about 350 nm, 375 nm, 400 nm, 425 nm, 450 nm, 475 nm, 500 nm, 525 nm, 550 m, 575 nm, 600 nm, 625 nm, 650 nm, 675 nm, 700 nm, 725 nm, 750 nm, 775 nm, 800 nm, 825 nm, 850 nm, 875 nm, or 900 nm. Those of skill in the art will recognize that, in some instances, the fluorescence excitation wavelength may have any value within this range of values, e.g., about 620 nm.

Fluorescence excitation light bandwidths: In some instances, the CAMS system may be configured for fluorescence imaging, e.g., single channel fluorescence imaging or multichannel fluorescence imaging. In some instances, at least one of the one or more light sources, alone or in combination with one or more optical components, e.g., excitation optical filters and/or dichroic beam splitters, may produce fluorescence excitation light at the specified excitation wavelength within a bandwidth of ±2 nm, ±5 nm, ±10 nm, ±20 nm, ±40 nm, ±80 nm, or greater. Those of skill in the art will recognize that, in some instances, the excitation light bandwidth may have any value within this range, e.g., about ±18 nm.

Fluorescence emission bands: In some instances, a detection unit or CAMS system may be configured to detect fluorescence emission at wavelengths that correspond to fluorescence emitted by any of a variety of fluorophores known to those of skill in the art. Examples of suitable fluorescence dyes for use in, e.g., genotyping and nucleic acid sequencing applications (e.g., by conjugation to nucleotides, oligonucleotides, or proteins) include, but are not limited to, fluorescein, rhodamine, coumarin, cyanine, and derivatives thereof, including the cyanine derivatives cyanine dye-3 (Cy3), cyanine dye-5 (Cy5), cyanine dye-7 (Cy7), etc.

Fluorescence emission wavelengths: In any of the fluorescence imaging configurations described herein, e.g., for single channel fluorescence imaging or multichannel fluorescence imaging configurations, the detection unit or CAMS system may be configured to collect emission light at about 350 nm, 375 nm, 400 nm, 425 nm, 450 nm, 475 nm, 500 nm, 525 nm, 550 m, 575 nm, 600 nm, 625 nm, 650 nm, 675 nm, 700 nm, 725 nm, 750 nm, 775 nm, 800 nm, 825 nm, 850 nm, 875 nm, or 900 nm. Those of skill in the art will recognize that, in some instances, the emission wavelength may have any value within this range, e.g., about 825 nm.

Fluorescence emission light bandwidths: In any of the fluorescence imaging configurations described herein, e.g., for single channel fluorescence imaging or multichannel fluorescence imaging configurations, the detection unit or CAMS system may be configured to collect light at the specified emission wavelength within a bandwidth of ±2 nm, ±5 nm, ±10 nm, ±20 nm, ±40 nm, ±80 nm, or greater. Those of skill in the art will recognize that, in some instances, the excitation bandwidths may have any value within this range, e.g., about ±18 nm.

Sample carrier devices: In some instances, the CAMS system may comprise one or more sample carrier devices, e.g., a sample carrier device on which a biological or chemical sample of interest is provided. In some instances, the relative motion unit or CAMS system may comprise translation and/or rotation stages adapted to hold an object of interest, e.g., a sample carrier device on which a biological or chemical sample of interest is provided. Examples of sample carrier devices include, but are not limited to, microscope slides, substrates, wafers, substrates, or wafers comprising modified surfaces and/or etched sample containment chambers (e.g., chambers open to the environment), flow cells, and microfluidic devices.

In some instances, the one or more sample carrier devices may be designed for performing a variety of chemical analysis, biochemical analysis, nucleic acid analysis, cell analysis, or tissue analysis applications. In some instances, for example, substrates, wafers, or flow cells may be adapted for performing nucleic acid sequencing. In some instances, a flow cell may be a closed flow cell comprising fluid inlets and outlets, and a sample chamber or compartment that is not open to the surrounding environment. In some instances, a flow cell may be an open flow cell comprising fluid inlets and outlets, and a sample chamber or compartment that is open to and/or accessible from the surrounding environment.

In some instances, the CAMS systems disclosed herein may comprise 1, 2, 3, 4, 5, 6, 7, 8, 9, 10, or more than 10 sample carrier devices. In some instances, the one or more sample carrier devices may be fixed components of the disclosed systems. In some instances, the one or more sample carrier devices may be removable, exchangeable components of the disclosed systems. In some instances, the one or more sample carrier devices may be disposable or consumable components of the disclosed systems.

Sample carrier devices for the disclosed CAMS systems (e.g., microscope slides, substrates, wafers, substrates or wafers comprising modified surfaces and/or etched sample chambers, flow cells, or microfluidic devices may be fabricated from any of a variety of materials known to those of skill in the art including, but not limited to, glass (e.g., borosilicate glass, soda lime glass, etc.), fused silica (quartz), silicon, polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET), polydimethylsiloxane (PDMS), etc.), polyetherimide (PEI) and perfluoroelastomer (FFKM; Kalrez) as more chemically inert alternatives, or any combination thereof.

In some instances, the materials used to fabricate sample carrier devices for the disclosed CAMS systems may be optically transparent to facilitate use with spectroscopic or imaging-based detection techniques. In some instances, the entire sample carrier device may be optically transparent. Alternatively, in some instances, only a portion of the sample carrier device (e.g., an optically transparent “window”) may be optically transparent.

The sample carrier devices for the disclosed CAMS systems may be fabricated using any of a variety of techniques known to those of skill in the art, where the choice of fabrication technique is often dependent on the choice of material used, and vice versa. Examples of suitable sample carrier device fabrication techniques include, but are not limited to, extrusion, drawing, precision computer numerical control (CNC) machining and boring, laser photoablation, photolithography in combination with wet chemical etching, deep reactive ion etching (DRIE), micro-molding, embossing, 3D-printing, thermal bonding, adhesive bonding, anodic bonding, and the like (see, e.g., Gale, et al. (2018), “A Review of Current Methods in Microfluidic Device Fabrication and Future Commercialization Prospects”, Inventions 3, 60, 1-25).

Fluidics modules and components: In some instances, a CAMS system configured to implement the methods disclosed herein may comprise one or more fluidics modules (or fluidics controllers) configured to control the delivery of fluids such as reagents and/or buffers to a sample, e.g., a sample positioned on or contained within a sample carrier device. In some instances, the one or more fluidics controllers may be configured to control volumetric flow rates for one or more fluids or reagents, linear flow velocities for one or more fluids or reagents, mixing ratios for one or more fluids or reagents, or any combination thereof. Fluidics modules may comprise one or more fluid flow sensors (e.g., flow rate sensors, pressure sensors, etc.), one or more fluid flow actuators (e.g., pumps), one or more fluid flow control devices (e.g., valves), one or more processors (and associated electronics), tubing and connectors to connect the one or more fluidics modules to one or more sample carrier devices, or any combination thereof.

The one or more fluidics modules may be configured to support any of a variety of fluid flow actuation mechanisms known to those of skill in the art. For example, in some instances, fluid flow may be controlled using one or more pumps, e.g., positive displacement pumps (e.g., diaphragm pumps, peristaltic pumps, piston pumps, syringe pumps, rotary vane pumps, etc.), metering pumps (e.g., oscillating positive displacement pumps designed for precise flow control), centrifugal pumps (e.g., rotary impellor pumps, axial impellor pumps), or any combination thereof.

In some instances, the fluidics module may comprise one or more valves to facilitate the control of fluid flow to sample carrier devices. Examples of suitable valves include, but are not limited to, check valves, electromechanical two-way or three-way valves, pneumatic two-way and three-way valves, or any combination thereof.

Temperature control modules: In some instances, a CAMS system configured to implement the methods disclosed herein may comprise one or more temperature control modules (or temperature controllers) configured to maintain a specified temperature at or within one or more sample carrier devices for the purpose of facilitating the accuracy and reproducibility of assay or analysis results. Examples of temperature control components that may be incorporated into sample carrier devices and/or the CAMS system and controlled by a temperature control module include, but are not limited to, resistive heating elements, infrared light sources, Peltier heating or cooling devices, heat sinks, thermistors, thermocouples, and the like.

In some instances, the temperature control module may be configured to maintain constant temperatures, to implement step changes in temperature, or to implement changes in temperature at a specified ramp rate over a specified temperature range. In some instances, the temperature control module may provide for a programmable temperature change at a specified, adjustable time prior to performing specific assay or analysis steps. In some instances, the temperature control module may provide for programmable changes in temperature over specified time intervals. In some instances, the temperature control module may further provide for cycling of temperatures between two or more set temperatures with specified frequency and ramp rates so that thermal cycling, e.g., for performing nucleic acid amplification reactions, may be performed.

In some instances, for example, the temperature within a sample carrier device may be held constant at a specified temperature of 10° C., 15° C., 20° C., 25° C., 30° C., 35° C., 40° C., 45° C., 50° C., 55° C., 60° C., 65° C., 70° C., 75° C., 80° C., 85° C., 90° C., or 95° C. (or at any temperature within this range). In some instances, the temperature within a sample carrier device may be held constant at a specified temperature to within ±0.1° C., ±0.25° C., ±0.5° C., 1° C., ±2.5° C., or ±5° C. (or at any tolerance within this range). In some instances, the temperature within a sample carrier device (e.g., a microfluidic device) may be ramped at a rate of 0.1° C./s, 0.5° C./s, 1° C./s, 5° C./s, 10° C./s, 50° C./s, 100° C./s, 500° C./s, or 1000° C./s (or at any temperature ramp rate within this range) (see, e.g., Miralles, et al. (2013), “A Review of Heating and Temperature Control in Microfluidic Systems: Techniques and Applications”, Diagnostics 3:33-67).

Motion control modules: In some instances, a CAMS system configured to implement the methods disclosed herein may comprise one or more motion control modules (also referred to herein as relative motion units or motion controllers) configured to control the position of one or more sample carrier devices relative to an objective lens of an optical detection system (or vice versa). In some instances, the motion control module may control the position of the sample carrier device in one dimension, two dimensions, or three dimensions (e.g., in the X-, Y-, and/or Z-directions) relative to the objective lens, or vice versa. In some instances, the motion control module may separately or additionally control a degree of rotation of the sample carrier device in one, two, or three dimensions, or vice versa. In some instances, the motion control module may be interfaced with, e.g., an imaging unit to also provide control of an autofocus mechanism. For example, the motion control module may be configured to adjust the focal plane by moving the sample carrier device and/or by moving an objective lens (or other optical component) of the imaging module. In some instances, the motion control module may be interfaced with an imaging unit to reposition a sample carrier device in the sample plane (e.g., the X-Y plane) between acquisition of a series of images that are subsequently used to create a composition image having a larger effective field-of-view than that of an individual image (e.g., to perform imaging tiling). In some instances, the motion control module may be interfaced with an imaging unit to reposition a sample carrier device in a direction parallel to the optical axis of the imaging module (e.g., in the Z-direction) between acquisition of a series of images that are subsequently used to create a three-dimensional representation of the sample (e.g., to perform volumetric imaging).

In some instances, the motion control module may comprise one or more (e.g., one, two, three, or more than three) translation stages, one or more (e.g., one, two, three, or more than three) rotational stages, one or more (e.g., one, two, three, or more than three) linear encoders, one or more (e.g., one, two, three, or more than three) rotary encoders, associated motors and control electronics, or any combination thereof. In some instances, the motion control module may further control components of an imaging unit such as an automated microscope objective lens turret or slide, an automated microscope tube lens turret or slide, or a microscope turret-mounted focus adjustment mechanism.

Suitable translation stages are commercially available from a variety of vendors, for example, Parker Hannifin. Precision translation stage systems typically comprise a combination of several components including, but not limited to, linear actuators, optical encoders, servo and/or stepper motors, and motor controllers or drive units. High precision and repeatability of stage movement is required for the systems and methods disclosed herein in order to ensure accurate and reproducible positioning and signal acquisition or imaging of, e.g., fluorescence signals when interspersing repeated steps of reagent delivery and optical detection.

System control module: In some instances, a CAMS system configured to implement the methods disclosed herein may comprise one or more system control modules (or system controllers) configured to synchronize and control data communication between other functional units of the system, e.g., the one or more illumination units, one or more detection units, one or more relative motion units, one or more counter-scan units, one or more fluidics modules, one or more temperature control modules, or any combination thereof. In some instances, the system control module may provide control of the motion of a sample carrier device relative to an objective lens of an optical detection system (or vice versa) using a feedforward control mechanism (e.g., where the relative motion between the sample carrier device and the objective lens of an optical detection system is synchronized, but no feedback mechanism is utilized). In some instances, the system control module may provide control of the motion of a sample carrier device relative to an objective lens of an optical detection system (or vice versa) using a feedback control mechanism (e.g., where a feedback loop based on a positional signal generated by a sensor such as a linear encoder or rotary encoder, or a relative motion signal generated by a sensor such as an accelerometer, is used to detect fluctuations in the relative motion and adjust the velocity and/or acceleration of a relative motion unit (e.g., a linear translation stage and/or rotational stage) accordingly to compensate for the fluctuations.

In some instances, a system control module may comprise one or more processors, one or more power supplies, one or more wired and/or wireless data communication interfaces, one or more memory storage devices, one or more user interface devices (e.g., keyboards, mice, displays, etc.), or any combination thereof. In some instances, the system control function may be provided by an external computer or computer system. In some instances, the one or more system control modules may interface with one or more external computers or computer systems.

System chassis and housing: As noted above, in some instances, the CAMS system may comprise an integrated system, e.g., where the different functional subsystems are mounted on a single framework or chassis and packaged within a single housing. In some instances, the CAMS system may comprise a modular system, e.g., where the different functional subsystems are mounted on separate frameworks or chassis and packaged in separate housings. The chassis may be constructed using any of a variety of materials (e.g., extruded aluminum or steel framing) and techniques (e.g., using fasteners, soldering, welding, etc.) known to those of skill in the art. Similarly, the housing (or enclosure) may be constructed using any of a variety of materials (e.g., sheet metal, plastic, etc.) and techniques (e.g., sheet metal bending, molding, etc.) known to those of skill in the art.

System control software: In some instances, the disclosed CAMS systems may comprise a processor or computer and computer-readable media that includes code for providing a user interface as well as manual, semi-automated, or fully-automated control of all system functions, e.g. control of one or more illumination unites, one or more detection units, one or more relative motion units, one or more counter-scan units, one or more fluid control modules, one or more temperature control modules, etc. As noted above, in some instances, the system processor or computer may be an integrated component of the system (e.g., a microprocessor or mother board embedded within a system control module). In some instances, the processor or computer may be a stand-alone personal computer or laptop computer.

Examples of imaging system control functions that may be provided by the system control software include, but are not limited to, autofocus capability, control of illumination or excitation light exposure times and intensities, control of image acquisition rate, exposure time, data storage options, and the like.

Examples of fluid flow control functions that may be provided by the system control software include, but are not limited to, volumetric fluid flow rates, fluid flow velocities, the timing and duration for sample and reagent additions, rinse steps, and the like.

Examples of temperature control functions that may be provided by the system control software include, but are not limited to, specifying temperature set point(s) and control of the timing, duration, and ramp rates for temperature changes.

Examples of motion control functions that may be provided by the system control software include, but are not limited to, range of travel, translation stage velocity, translation stage acceleration, translation stage positioning accuracy, degree of rotation, rate of rotation, rate of rotational acceleration, rotational stage positioning accuracy, and the like.

Data analysis software: In some instances, the disclosed systems may comprise one or more data analysis and visualization software packages. Examples include, but are not limited to, signal and/or image processing software, image analysis software, statistical analysis software, data visualization and display software, and the like.

Examples of signal/image processing and analysis capability that may be provided by the software include, but are not limited to, manual, semi-automated, or fully-automated image exposure adjustment (e.g. white balance, contrast adjustment), manual, semi-automated, or fully-automated image noise adjustment (e.g., signal-averaging, filtering, and/or other noise reduction functionality, etc.), manual, semi-automated, or fully-automated edge detection and object identification (e.g., for identifying clusters of amplified template nucleic acid molecules on a substrate surface), manual, semi-automated, or fully-automated signal intensity measurements and/or thresholding in one or more detection channels (e.g., one or more fluorescence emission channels), manual, semi-automated, or fully-automated statistical analysis (e.g., for comparison of signal intensities to a reference value for base-calling purposes in nucleic acid sequencing applications).

Any of a variety of image processing and analysis algorithms known to those of skill in the art may be used to implement real-time or post-processing image analysis capability. Examples include, but are not limited to, the Canny edge detection method, the Canny-Deriche edge detection method, first-order gradient edge detection methods (e.g. the Sobel operator), second order differential edge detection methods, phase congruency (phase coherence) edge detection methods, other image segmentation algorithms (e.g. intensity thresholding, intensity clustering methods, intensity histogram-based methods, etc.), feature and pattern recognition algorithms (e.g. the generalized Hough transform for detecting arbitrary shapes, the circular Hough transform, etc.), and mathematical analysis algorithms (e.g. Fourier transform, fast Fourier transform, wavelet analysis, auto-correlation, etc.), or combinations thereof.

Any of a variety of statistical analysis methods known to those of skill in the art may be used in processing data generated by performing the disclosed methods. Examples include, but are not limited to, clustering, eigenvector-based analysis, regression analysis, probabilistic graphical modeling, or any combination thereof.

In some instances, the system control and data analysis software (e.g., image processing/analysis software, statistical analysis software, etc.) may be written as separate software modules. In some instances, the system control and image processing/analysis software may be incorporated into an integrated software package.

### V. Computer Processors and Computer Systems

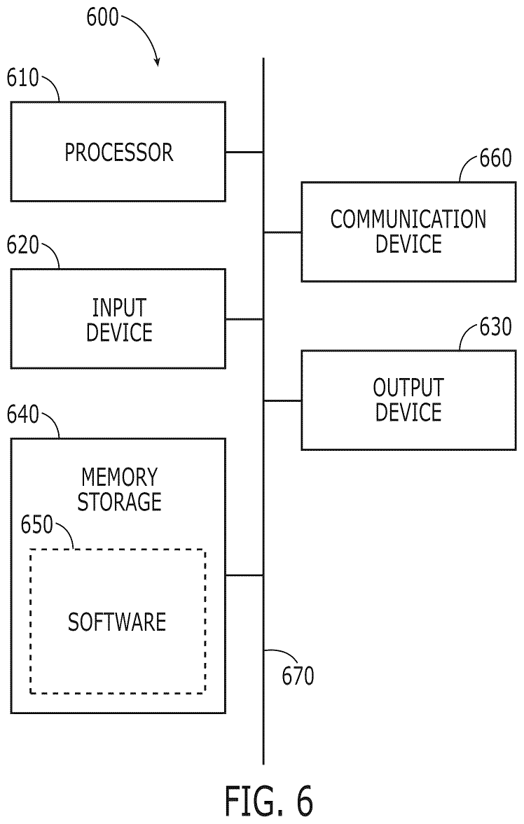

FIG. 6 illustrates an example of a computing device or system in accordance with one or more examples of the disclosure. Device 600 can be a host computer connected to a network. Device 600 can be a client computer or a server. As shown in FIG. 6, device 600 can be any suitable type of microprocessor-based device, such as a personal computer, workstation, server, or handheld computing device (portable electronic device), such as a phone or tablet. The device can include, for example, one or more of a processor 610, input device 620, output device 630, memory/storage 640, and communication device 660. Input device 620 and output device 630 can generally correspond to those described above, and they can either be connectable to or integrated with the computer.

Input device 620 can be any suitable device that provides input, such as a touch screen, keyboard or keypad, mouse, or voice-recognition device. Output device 630 can be any suitable device that provides output, such as a touch screen, haptics device, or speaker.

Storage 640 can be any suitable device that provides storage, such as an electrical, magnetic, or optical memory including a RAM, cache, hard drive, or removable storage disk. Communication device 660 can include any suitable device capable of transmitting and receiving signals over a network, such as a network interface chip or device. The components of the computer can be connected in any suitable manner, such as via a physical bus 670 or wirelessly.

Software 650, which can be stored in memory/storage 640 and executed by processor 610, can include, for example, the programming that embodies the functionality of the present disclosure (e.g., as embodied in the devices described above).

Software 650 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can implement any operating system suitable for operating on the network. Software 650 can be written in any suitable programming language, such as C, C++, Java, or Python. In various implementations, application software embodying the functionality of the present disclosure can be deployed in different configurations, such as in a client/server arrangement or through a web browser as a web-based application or web service, for example.

### VI. Methods of Use/Applications

The disclosed methods and systems may be used for any of a variety of optical scanning and imaging applications requiring high throughput and/or the interrogation of large objects (or surfaces on or areas within large objects). Examples of potential applications include, but are not limited to, machine vision systems used for the inspection and characterization of semiconductor wafers, imaging-based nucleic acid sequencing platforms for the life sciences and clinical diagnostics, high content imaging of live cells to determine cellular responses to environmental stimuli, biochemical signaling molecules, drug candidates, etc., and the like.

Nucleic acid sequencing: Many imaging-based “next generation” sequencing technologies utilize a massively parallel, cyclic array approach to perform sequencing-by-nucleotide incorporation (also referred to as “sequencing-by-synthesis” or SBS), in which accurate decoding of a single-stranded template oligonucleotide sequence tethered to a solid support relies on successfully classifying signals (e.g., fluorescence signals detected using an imaging technique) that arise from the stepwise addition of A, G, C, and T nucleotides by a polymerase to a complementary oligonucleotide strand. These methods typically require oligonucleotide template molecules to be modified with a known adapter sequence of fixed length, affixed to a solid support (e.g., the lumen surface(s) of a flow cell device) in a random or patterned array by hybridization to surface-tethered capture probe sequences that are complementary to the adapter sequence, clonally-amplified to create colonies of template sequences (each comprising multiple copies of a single template sequence) at a plurality of sites on the support surface, and then probed through a cyclic series of single base addition primer extension reactions that use, e.g., fluorescently-labeled nucleotides to identify the sequence of bases in each template oligonucleotide colony. In order to achieve high-throughput sequencing, single nucleotide incorporation reactions are monitored in parallel at hundreds-of-thousands to millions of colony sites distributed across a support surface that may be many times larger than the field-of-view of an imaging system having a sufficiently high spatial resolution capabilities to resolve individual colonies. A conventional approach to address this field-of-view limitation is to acquire multiple images, each offset from the previously acquired image, that collectively “tile” the surface and can be used to create a composite image comprising a field-of-view that is much larger than the field-of-view of the imaging system. As noted previously, this approach has the disadvantage that the system must alternate between steps of maintaining the support surface at a fixed position relative to the optical detection system for as long as necessary to acquire an image and moving the support (or the imaging system) to the next image acquisition position. This stop-and-go motion entails acceleration and deceleration of the support (or of the imaging system), which takes time and limits the throughput of the imaging system.

The CAMS systems disclosed herein can enable more efficient high-throughput imaging of support surfaces used in nucleic acid sequencing applications by allowing continuous movement of the support relative to the imaging system or vice versa (see, e.g., the sequencing platform described by Almogy, et al. (2022), “Cost-Efficient Whole Genome-Sequencing Using Novel Mostly Natural Sequencing-by-Synthesis Chemistry and Open Fluidics Platform”, bioRxiv 2022.05.29.493900, that utilizes an open flow cell design on a circular wafer). The counter-scan unit of a CAMS system can compensate for the relative motion and ensure that high resolution images of the support surface are acquired.

In addition to their utilization in nucleic acid sequencing platforms that rely on sequencing-by-synthesis (SBS) biochemistry, the disclosed CAMS systems are also applicable to any imaging-based nucleic acid sequencing platform, including those that utilize alternative sequencing biochemistries. Examples include, but are not limited to, the “sequencing-by-binding” approach described in U.S. Pat. Nos. 9,951,385 and 10,655,176, and the “sequencing-by-avidity” approach described in U.S. Pat. Nos. 10,768,173 and 10,982,280.

The “sequencing-by-binding” (SBB) approach is based on performing repetitive cycles of detecting a stabilized complex that forms at each position along the template (e.g., a ternary complex that includes the primed template (tethered to a sample support structure), a polymerase, and a cognate nucleotide for the position), under conditions that prevent covalent incorporation of the cognate nucleotide into the primer, and then extending the primer to allow detection of the next position along the template (see, e.g., U.S. Pat. Nos. 9,951,385 and 10,655,176). In the sequencing-by-binding approach, detection of the nucleotide at each position of the template occurs prior to extension of the primer to the next position. Generally, the methodology is used to distinguish the four different nucleotide types that can be present at positions along a nucleic acid template by uniquely labelling each type of ternary complex (i.e., different types of ternary complexes differing in the type of nucleotide it contains) or by separately delivering the reagents needed to form each type of ternary complex. In some instances, the labeling may comprise fluorescence labeling of, e.g., the cognate nucleotide or the polymerase that participates in the ternary complex.

The “sequencing-by-avidity” (or SBA) approach relies on the increased avidity (or “functional affinity”) derived from forming a complex comprising a plurality of individual non-covalent binding interactions (see, e.g., U.S. Pat. Nos. 10,768,173 and 10,982,280). The sequencing-by-avidity approach is based on the detection of a multivalent binding complex formed between a fluorescently labeled polymer-nucleotide conjugate, a polymerase, and a plurality of primed target nucleic acid molecules tethered to a sample support structure, which allows the detection/base calling step to be separated from the nucleotide incorporation step. Fluorescence imaging is used to detect the bound complex and thereby determine the identity of the N+1 nucleotide in the target nucleic acid sequence (where the primer extension strand is N nucleotides in length).

### EXAMPLES

### Example 1—Comparison of TDI Line Scanning and CAMS Systems

For a prototype CAMS system based on area mode fluorescence imaging, the speed of a rotation stage supporting a rotating wafer to be imaged and the pulse repetition rate for a laser used to provide illumination were synchronized to provide relative motion of one image frame for every laser pulse. The pulse duration (integration time) was set at ˜50 μs to provide adequate excitation light intensity while avoiding photo-bleaching damage to the object (e.g., to the labeled oligonucleotides tethered to the wafer). Ordinarily, imaging using such a long laser pulse for excitation of fluorescence would cause “smearing” of the image, as the image of the wafer moves across the image sensor at a rate of about 1 pixel per 0.6 μs (1/frame-height/frame-rate˜1/4000 pixels/400 Hz=0.63 μs), and a shift of about one half of a pixel (occurring in ˜0.3 μs) would cause noticeable image degradation.

The CAMS systems described herein provide a solution to the issue of image smearing by counter-scanning of the image to maintain its position on the camera sensor during the duration of the laser pulse. The laser illumination area can also be scanned, but this is not required as the motion of the wafer during the duration of the laser pulse used in this example was much smaller than the illumination area (i.e., a shift of ˜80 pixels out of 4,000 pixels in this case, or about 2% of the FOV) so a slightly larger area (e.g., on the object) can be illuminated. In some instances, counter-scanning of the illumination may be preferable to prevent double-exposure of some areas.

Counter-scanning can be achieved by using, e.g., a galvo mirror or an oscillating optical element (e.g., a flat glass element). The approach has high tolerance with regards to pulse-to-pulse repeatability (which is corrected by alignment, so a tolerance of less than about 1% of the FOV should suffice). Scan speed uniformity within the image integration time is required (e.g., to prevent a shift of less than 0.5 pixels over an 80-pixel integration one must control the scan speed to within 1/160^{th} of the set speed).

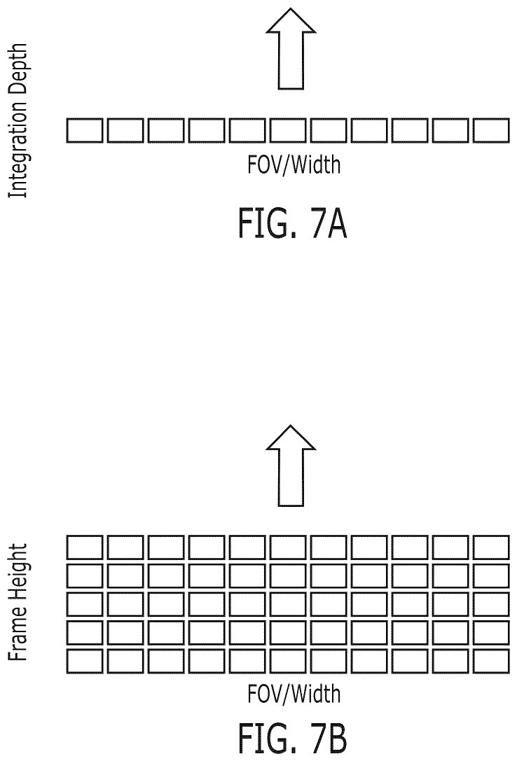

The benefits of the CAMS approach include: (i) achievement of data rates similar to those achieved using TDI line scanning but from a narrower FOV, (ii) if a single camera has too limited a data rate, one can use multiple cameras to image the same objective FOV, and (iii) in the case of a wedged counter-scan unit (as described elsewhere herein), may enable imaging of even the innermost radius without smear. The use of a narrow FOV, as enabled herein by CAMS, has multiple additional benefits, including: i) allowing the use of less expensive and lighter objectives (and making autofocus (AF) easier), ii) reducing wafer flatness requirements within the smaller FOV, iii) permitting higher scanning speed (requires higher bandwidth AF), iv) allowing the use of more compact and lower cost optical path designs that yield the smaller FOVs which, in combination with the potentially smaller pixel sizes available for area mode cameras, may reduce the magnification required, v) simplifying the illumination path (e.g., no cylindrical optical elements are required) so that these optical elements are easier to align, vi) ensuring that the laser power is uniform for the entire image frame, and vii) reducing sensitivity to vibration, as the same vibration occurs in the counter-scan axis. FIG. 7A and FIG. 7B provide schematic illustrations of TDI line scanning and area mode imaging, respectively.

Time delay and integration (TDI) scanning enables a combination of high-throughput imaging with high signal-to-noise ratio (SNR) by accumulating the image-forming signal onto a two-dimensional sensor pixel array that shifts the acquired image signal from one row of pixels in the pixel array to the next row of pixels synchronously with the motion of an object being imaged as it is moved relative to the imaging system, or vice versa, in one dimension. TDI line scan cameras typically comprise a large number of pixels across the field-of-view (e.g., 8,192 (8K), 16,384 (16K) or 32,768 (32K) pixels), but a relatively small number of pixels in the direction of integration (e.g., 32, 64, or 128 pixels; the integration depth), as illustrated schematically in FIG. 7A. Exemplary calculations of the estimated performance specifications for two prototype imaging systems based on TDI line scanning are summarized in Table 1 below.

Area mode sensors (e.g., conventional CCD or CMOS image sensors) comprise two-dimensional arrays of pixels (with total pixel counts that may range from, e.g., less than 1 megapixel to tens or hundreds of megapixels) and that may have varying, but typically much smaller, aspect ratios (i.e., ratios of width-to-height) than TDI line scan cameras that depend on the distribution of pixels over the rows and columns of the pixel array (e.g., 1,024 pixels wide×1,024 pixels high, 4,480 pixels wide×2,496 pixels high, 1,932 pixels wide×1,216 pixels high, etc.), as illustrated schematically in FIG. 7B. Exemplary calculations of the estimated performance specifications for a prototype CAMS imaging system based on area mode imaging are summarized in Table 2 below.

As can be seen by comparing the performance specifications summarized in Table 1 and Table 2, for a somewhat smaller width field-of-view, the CAMS approach allows a higher throughput scan speed (e.g., 32 cm/sec vs 16 cm/sec or 13 cm/sec). Furthermore, whereas TDI line scanning only compensates for relative motion in one dimension, the CAMS approach can compensate for arbitrary combinations of linear and/or rotational motion, as described herein above and in the following examples.

TABLE 1
TDI Line Scanning System Performance Specifications

| | Calculation or | | |
|---|---|---|---|
| Specification | Description | TDI Line Scan Proto. 1 | TDI Line Scan Proto. 2 |
| Scan Speed | Pixel size × Line rate | 0.325 μm/pixel × 400 kHz = | 0.2 μm pixels × 800 |
| | | 13 cm/sec | kHz = 16 cm/sec |
| Field-of-View | Pixel size × # pixels | 0.325 μm/pixel × 8,000 | 0.2 μm/pixel × 16,000 |
| (width) | | pixels = 2.6 mm | pixels = 3.2 mm |
| Data Rate | # Pixels × Line rate | 8,000 pixels × 400 | 16,000 pixels × 800 |
| | | kHz = 3.2 gigapixels/sec | kHz = 12.8 gigapixels/sec |
| Integration | Image shift (in pixels) | ~20 pixels | ~40 pixels |
| Depth | during the signal | | |
| | acquisition/integration step | | |
| | for an image frame | | |
| Dwell Time | Integration depth/line rate | ~20 pixels/400 kHz = 50 μs | ~40 pixels/800 kHz = 50 μs |

TABLE 2
Area Mode Imaging System Performance Specifications

| Specification | Calculation | CAMS Imaging Prototype |
|---|---|---|
| Scan Speed (where scanning occurs | Pixel size × frame height (# | ~0.20 μm × 4,000 pixels × |
| parallel to the plane of frame height) | pixels-height) × frame rate | 400 Hz = 32 cm/sec |
| Field-of-View (width) | Pixel size × # pixels-width | 0.2 μm × 8,000 pixels = 1.6 mm |
| Data Rate | # pixels-width × # | 8,000 pixels × 4,000 pixels × |
| | pixels-height × frame rate | 400 HZ = 12.8 gigapixels/sec |
| Integration Depth (e.g., | Dwell time × frame rate × | 50 μs × 400 Hz × 4,000 |
| counter scan range) | frame-height (# pixels-height) | pixels = 80 pixels |
| Dwell Time | = strobe pulse time | 50 μs = 80 pixels/4,000 |
| | | pixels/400 kHZ |

### Example 2—Laser Peak Power Requirements

For CAMS systems using a laser to provide excitation light for fluorescence imaging applications, the laser power requirement is inversely proportional to the duty cycle (DC) of the counter-scan unit, which can be calculated as the ratio of the counter-scan range (CSR) (e.g., the shift of the image relative to its position at the start of the acquisition phase, in units of pixels) to the camera depth (CD) (e.g., the frame-height, in units of pixels):

Duty Cycle=Counter-Scan Range/Camera Depth.

For example, a counter-scan range of 80 pixels on a sensor having a camera depth (or frame-height) of 4,000 pixels would correspond to a duty cycle of 80/4000=0.02 (or 2%). In another example, a counter-scan range of 200 pixels on a sensor having a camera depth (e.g., frame-height) of 1,000 pixels would correspond to a duty cycle of 200/1000=0.20 (or 20%).

In systems with rotational motion (e.g., a spinning object to be imaged), CSR is limited by the inner radius smear (e.g., there will be more smearing at radii closer to the center of wafer 1000 during imaging with relative rotational motion between wafer 1000 and an imaging system, as described in Example 5 below). To a lesser extent, CSR may also be limited by galvo mirror speed control and stage vibration during integration (e.g., in TDI imaging). For example, for an 8K camera (e.g., a camera with a frame-height of 8,000 pixels) positioned with its innermost edge at 30 mm from the axis of rotation, a CSR of 40 pixels was achieved with minimal image smear, which corresponds to a duty cycle of 40/8000=0.005 (or 0.5%).

If peak laser power is limiting, a higher duty cycle is desirable. As the FOV of a camera decreases in width, there will in general be less observable image smear than. As the FOV of a camera decreases in depth (e.g., frame height), for a same given level of smear, higher duty cycles are possible. Thus, in situations where a higher duty cycle is required, there may be an advantage to reducing camera depth (despite the typical preference for larger FOV to speed imaging throughput).

In some cases, a continuous wave (CW) laser may be required. In such cases, the camera should be “gated” to avoid smearing when the counter-scan mirror returns (gating may not be required if the counter-scan unit consists of, e.g., a rotating polygon mirror or an acousto-optic deflector (AOD) with a fast switch). By using a gated camera, the camera is not collecting light while the galvo mirror is returning to its starting position, while the polygon mirror is switching facets, or when the AOD starts a new scan.

### Example 3—Calculation of Image Smear Due to Linear and Rotational Motion

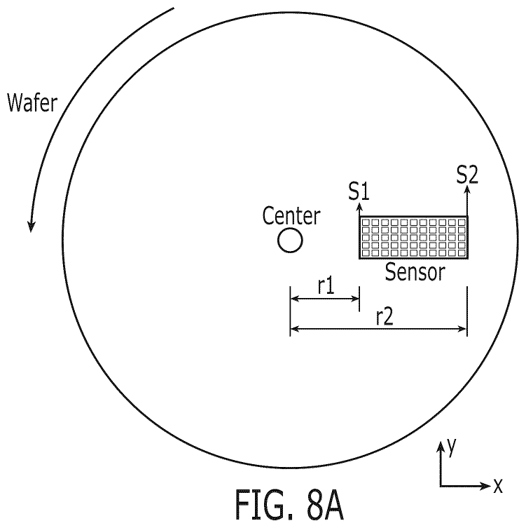

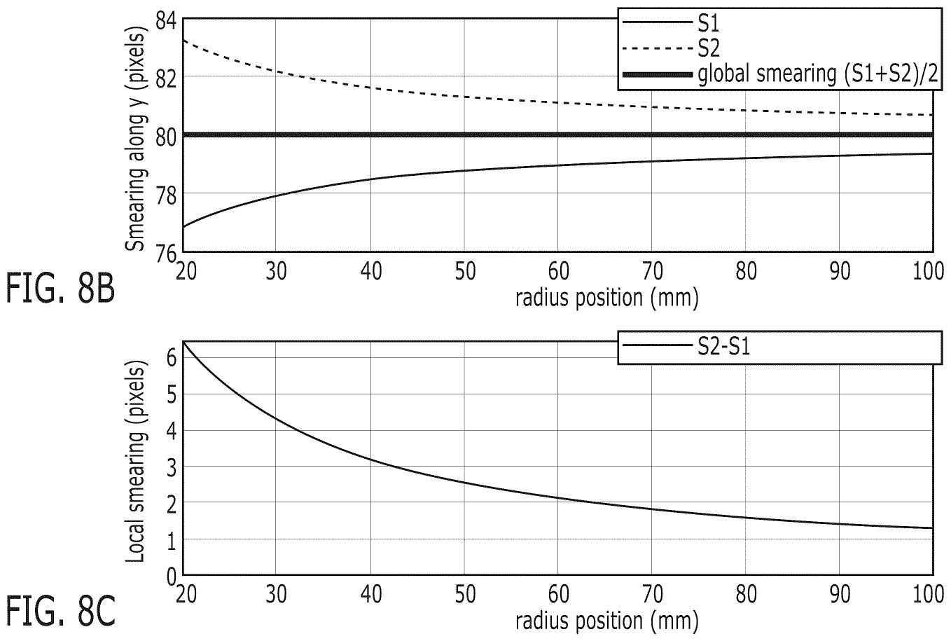

In some applications of the Counter-Scan Area Mode Strobe (CAMS) concept, area mode cameras may be used to image an object (e.g., a rotating wafer). As illustrated in FIG. 8A, during the image acquisition period (or dwell time), the wafer moves by distances S1 and S2 at r1 (corresponding to the innermost edge of the camera sensor) and r2 (the outermost edge), respectively. Since S2 is larger than S1 due to the difference in radius (r2>r1), the image smearing resulting from the relative motion between the sensor and wafer can be separated into two components: a linear term and a rotational term. The linear term is proportional to (S1+S2)/2, the distance (in units of pixels) the wafer moves relative to the camera at the center position of the camera (i.e., at (r1+r2)/2). The rotational component is characterized by the angle α=atan

$$( \frac{S 2 - S 1}{m} )$$

where m is the number of sensor pixels in the horizontal (radial) direction. In the example shown in FIG. 8A, the angle is small (α=0.04° when the center of the image sensor (8,000 pixels (m)×4,000 pixels (n)) is positioned 20 mm from the center of a 100 mm radius wafer (S2−S1 is approximately 6 pixels).

FIG. 8B provides a non-limiting example of the calculated image smear (in units of pixels) in images acquired by a stationary camera (in the absence of counter-scanning) as a function of the radial center position of the camera's image sensor relative to the rotating wafer. For this example, the camera was assumed to have a pixel size of 8,000 (m)×4,000 (n) pixels, the pixel size was 0.2 μm/pixel, the frame rate was 400 Hz, and the dwell time (i.e., the exposure or image acquisition time, or the pulse duration of the illumination) was 50 μs. As noted above, during the dwell time the wafer moves by a distance of S1 relative to the sensor at r1 (corresponding to the innermost edge of the camera sensor), and by a distance of S2 relative to the sensor at r2 (the outermost edge). The plot in FIG. 8B shows the calculated values of S1, S2, and their mean value, as a function of the radial position of the center of the camera sensor (i.e., at r=(r1+r2)/2). The calculated global smearing (i.e., the average smearing (or relative motion) across the width of the sensor) in the y-direction (i.e., the direction perpendicular to the radial direction) is about 80 pixels in this example. As can be seen in FIG. 8B, the difference in the degree of smearing exhibited between the innermost and outermost edges of the sensor (i.e., S2−S1) is largest at small radius, and decreases as the radius (i.e., the radial position at the midpoint of the sensor) increases.

FIG. 8C shows the calculated degree of local image smearing in units of pixels (i.e., the difference in the degree of image smearing exhibited between the innermost and outermost edges of the sensor as plotted in FIG. 8B) as a function of the radial position of the sensor midpoint relative to the rotating wafer. The value of local smearing in this non-limiting example ranges from about 6 pixels at the innermost radius to about 1 pixel at the outermost radius. The image smearing in this example has two components, i.e., a global (linear) component and a local (rotational) component. As noted above, the rotational angle is given by

$$α = a tan ( \frac{S 2 - S 1}{m} ) .$$

If the center of the camera is positioned at 20 mm from the center of the wafer, the width of the sensor (S2−S1) is about 6 pixels and α=0.040.

These calculations can be extended to estimate the linear and angular velocities required to be compensated for by a counter-scan unit, and the accuracies with which they must be controlled. Assume that the camera sensor's pixels have a pitch 5 μm, and that the tube lens in front of the camera has a focal length of 194 mm. Given that the dwell time is 50 μs and the global smearing (translational component) is 80 pixels, the linear velocity in the camera frame-of-reference is (80 pixels×5 μm)/(50 μs)=8 mm/ms, which will require a counter-scan speed of about 1.2°/ms (using the small angle approximation, the rate of change in mechanical angle is approximately equal to (8 mm/ms)/(2)/(194 mm)×(180 degrees/pi radians)), and an accuracy of better than 1.2°/80=0.015°. For the rotational component, the required maximum rotation angle in the camera's frame-of-reference is 0.04°, which leads to a maximum angular counter-scan speed of 0.04°/50 μs=0.8°/ms, and an accuracy of better than 0.04°/6 pixels=0.0067° in the camera's frame of reference.

The residual relative speed between the stationary camera sensor and the wafer, i.e., after correcting for “global” smearing (e.g., by correcting for the average relative linear velocity between the rotating wafer and the midpoint of the camera sensor) indicates that the image must also be rotated to adequately correct for relative motion in this example. In some instances, the use of a counter-scan unit comprising two galvo-mirrors may compensate for the rotational component of relative motion, as will be described in Example 4 below.

### Example 4—Correction of Image Smear Using Two Galvo-Mirrors

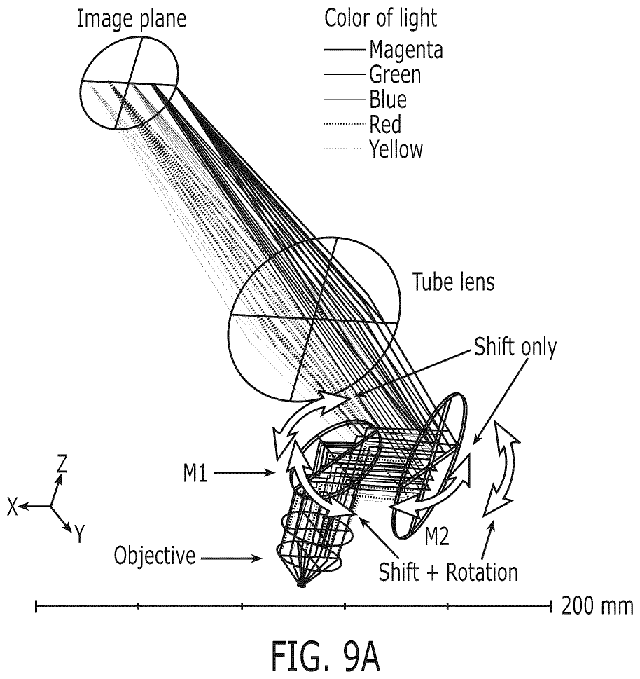

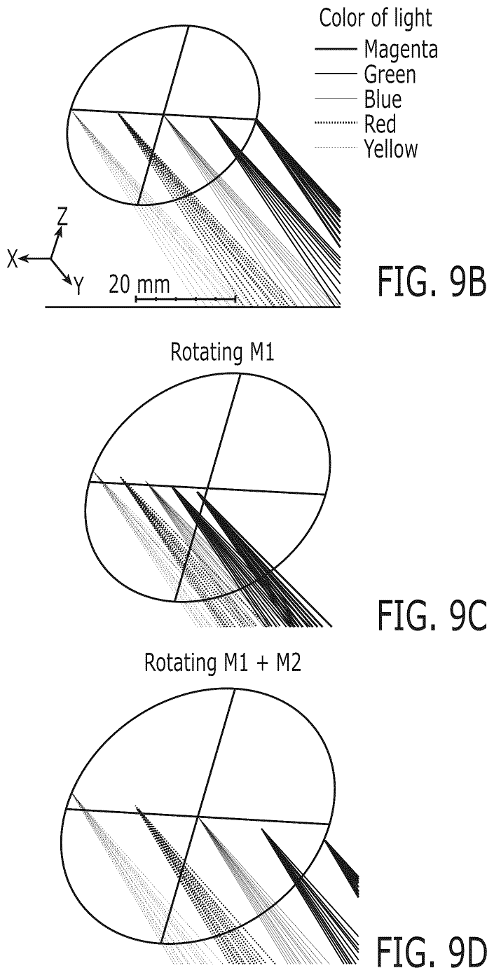

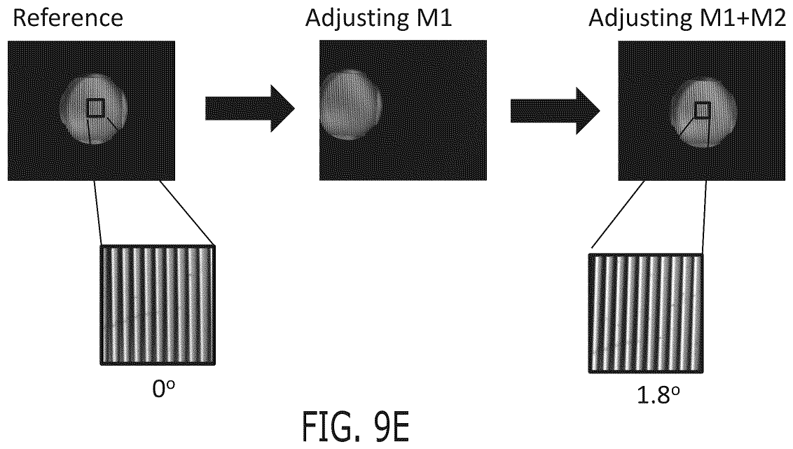

FIG. 9A provides a non-limiting schematic illustration of a CAMS optical detection system comprising a counter-scan subsystem that utilizes two galvo-mirrors for redirecting light to compensate for both linear and rotational motion. FIG. 9A provides a simplified optical diagram showing the objective, the tube lens, and the two counter-scan mirrors, M1 and M2, positioned between the objective and tube lens. Rotating M1 about the y axis and M2 about the z axis, respectively, results only in linear shifts of the image in the image plane. Rotating M1 about both the y axis and z axis results in a shift and rotation of the image in the image plane. Similarly, rotating M2 about both the z axis and the x axis results in a shift and rotation of the image in the image plane.

FIG. 9B provides a non-limiting schematic illustration of the projection of five field points aligned with the x axis onto the image plane by the counter-scan unit of the CAMS system. If M1 is adjusted, e.g., tilted by 5° about the x axis, the field is not only shifted but also rotated, as shown in FIG. 9C. The center of the field can be kept stationary during rotation (as shown in FIG. 9D) by adjusting the tip/tilt of the second mirror M2 to move the blue center ray trace back to the center of the field. Each counter-scan mirror has two degrees of freedom, one of which only adjusts shift, while the other leads to both shift and rotation of the field. Two counter-scan mirrors arranged as shown in FIG. 9A are able to produce arbitrary combinations of linear shift and rotation of the field within a certain range.

FIG. 9E illustrates a proof of concept of the system described above with regards to mirrors M1 and M2 adjustment. In FIG. 9E, adjustment of M1 results in a lateral shift of the image in the image plane (middle pane), in accordance with the schematic illustrated in FIG. 9C. In FIG. 9E, adjustment of both M1 and M2 results in rotation by no lateral shift of the image in the image plane (right pane), in accordance with the schematic illustrated in FIG. 9D. Adjustment of M1 in this example results in a left-ward lateral shift of the image in the image plane (in comparison to the original image—left pane) but no rotation. Adjustment of both M1 and M2 in this example results in a rotation of the image in the image plane by 1.8° (in comparison to the original image—left pane—is not rotated at all (0°)).

### Example 5—Use of a Magnification Gradient to Correct for Relative Motion

As noted above, another counter-scanning strategy (referred to herein as “wedged counter-scanning”) for compensating for rotational motion (e.g., where a rotating wafer is imaged by a stationary camera) is to create a gradient of magnification across the field-of-view of the camera's image sensor. FIG. 10A illustrates the concept of wedged counter scanning in a top-down view of the object (e.g., the wafer 1000) to be imaged. During the camera exposure time used to acquire an image, the wafer moves a distance h1 at radial position r1 as measured from the center of the wafer (e.g., the innermost edge of the sensor) and a distance of h2 at radial position r2 (e.g., the outermost edge of the sensor). Wedged counter scanning (e.g., to reduce smearing across the FOV) is achieved by creating a magnification gradient across the field-of-view of the camera such that the ratio of the magnification at r2 to that at r1 (magnification ratio, MR) is given by MR=h2/h1=r2/r1=1+(L/r1), where L is the field-of-view along the x (radial) axis. Assuming L is 1.6 mm and r=60 mm, then the ratio of magnification at r2 versus r1 is MR=1.03.

FIG. 10B and FIG. 10C provide non-limiting schematic illustrations of optical designs comprising tiltable optical elements for creating and adjusting magnification gradients by changing the working distance. FIG. 10B illustrates a typical Scheimpflug optical microscope design with a tilted objective (OB) and tilted camera sensor that can be used to enable wedged counter-scanning. The magnification, M1, at r1 is given by M1=L1/WD1, where L1 is the distance between the objective and camera sensor, and WD1 is the working distance (i.e., the separation distance between the object being imaged and the objective) at r1, while the magnification, M2, at r2 is given by M2=L2/WD2, where L2 is distance between the objective and camera sensor, and WD2 is the working distance at r2. By tilting the objective and/or the camera, one can adjust the ratio M2/M1. FIG. 10C illustrates an extension of Scheimpflug optical microscope design that comprises an objective, tube lens, and camera where the objective, tube lens, and/or camera are tiltable. The tilt angles illustrated in the optical configurations shown in FIGS. 10B and 10C are static for a given radial position of the camera sensor but would be adjusted as the camera is positioned at different radii (e.g., where r1 and r2 are changed).

FIGS. 10D and 10E provide examples illustrating the creation of magnification gradients by adjusting the working distance(s) of the optical system. In these examples, the focal lengths of the objective and tube lens were 12.3 mm and 193.7 mm, respectively. The nominal magnification of the system is 15.75×. FIG. 10D provides a plot of the calculated magnification as a function of the working distance displacement. At the nominal distance between the objective and tube lens (e.g., when the back focal plane of the objective is superimposed with the front focal plane of the tube lens in a 4-f system configuration; for example, 194 mm+12.3 mm=206.3 mm), the system is more or less telecentric. Reducing the working distance by 0.1 μm thus only yields a change in magnification of about 1.025×. In such a setup, the working distance must be changed by about 150 μm to get approximately 4% change of magnification. To break the telecentricity of the optical design, reduce or increase the distance between the tube lens and objective can be decreased or increased. FIG. 10E provides a plot of the calculated magnification as a function of the working distance displacement where the distance between the objective and tube lens is reduced by 50 mm as compared to the setup in FIG. 10D. Reducing the working distance by 0.1 mm in this case yields a change in magnification of about 1.06×. In comparison with the setup in FIG. 10D, the working distance only needs to be displaced by 75 μm to have 4% change of magnification when the distance between objective and tube lens is reduced by 50 mm.

The results from the simulations in FIGS. 10D and 10E can be used to inform the amount of tilt (e.g., between a sample and an objective as illustrated in FIG. 10B or between a sample and an objective and between the sample and a tube lens as illustrated in FIG. 10C) that is required to obtain the desired magnification gradient across a FOV (e.g., as illustrated in FIG. 10A).

### EXEMPLARY EMBODIMENTS

Exemplary embodiments of the methods and systems described herein include:

1. A method comprising:
changing a deflection angle of light relayed within an optical system and projected onto one or more optical sensors using at least one optical component having a time-dependent orientation to correct for relative motion between an object and the one or more optical sensors,
wherein the change in deflection angle results in delivery of a motion-invariant optical signal to the one or more optical sensors for a specified signal acquisition time.
   2. The method of embodiment 1, wherein the light projected onto the one or more optical sensors comprises light that is transmitted, reflected, or emitted by the object.
   3. The method of embodiment 1, wherein illumination light is projected onto an area of the object that is greater than or equal to an area of a field-of-view of the one or more optical sensors for the specified signal acquisition time.
   4. The method of embodiment 1, wherein an angle of illumination light projected onto the object is changed using at least one optical component having a time-dependent orientation to correct for relative motion between the object and a light source that provides the illumination light.
   5. The method of embodiment 4, wherein the illumination light projected onto the object comprises an area of substantially uniform illumination light intensity.
   6. The method of embodiment 4 or embodiment 5, wherein the light source comprises a laser.
   7. The method of embodiment 6, wherein the laser comprises a pulsed laser that is synchronized with signal acquisition.
   8. The method of embodiment 4, wherein the illumination light projected onto the object provides structured illumination.
   9. The method of any one of embodiments 1 to 8, wherein changing the deflection angle of light projected onto the one or more optical sensors is repeated for two or more signal acquisition cycles, each cycle comprising a signal acquisition step and a rewind step, to acquire optical signals corresponding to two or more areas of the object.
   10. The method of embodiment 9, wherein the two or more areas are contiguous.
   11. The method of any one of embodiments 1 to 10, wherein the one or more optical sensors have a same field-of-view.
   12. The method of any one of embodiments 1 to 10, wherein the one or more optical sensors have different fields-of-view.
   13. The method of any one of embodiments 1 to 12, wherein the relative motion between the object and the one or more optical sensors comprises linear motion, rotational motion, or any combination thereof within a two-dimensional plane.
   14. The method of any one of embodiments 1 to 13, wherein the relative motion between the object and the one or more optical sensors comprises rotational motion within a two-dimensional plane.
   15. The method of any one of embodiments 1 to 14, wherein changing the deflection angle of light projected onto the one or more optical sensors comprises the use of two or more galvo-mirrors.
   16. The method of embodiment 15, wherein the two or more galvo-mirrors are positioned between an objective lens and a tube lens used to relay the optical signal to the one or more optical sensors.
   17. The method of embodiment 15, wherein the two or more galvo-mirrors are positioned between a tube lens used to relay the optical signal and the one or more optical sensors.
   18. The method of any one of embodiments 15 to 17, wherein each of the two or more galvo-mirrors have two tilt axes, and at least one of the two tilt axes is perpendicular to a two-dimensional plane within which the relative motion between the object and the one or more optical sensors occurs.
   19. The method of any one of embodiments 1 to 14, wherein changing the deflection angle of light projected onto the one or more optical sensors comprises the use of a rotational stage on which the one or more optical sensors are mounted and a reflector comprising at least one axis of tilt.
   20. The method of embodiment 19, wherein the reflector comprises a dichroic mirror.
   21. The method of any one of embodiments 1 to 14, wherein changing the deflection angle of light projected onto the object to the one or more optical sensors comprises the use of a polygon mirror, a micromirror array, an acousto-optic deflector, a liquid crystal element, a liquid crystal array, or any combination thereof.
   22. The method of any one of embodiments 1 to 14, wherein changing the deflection angle of light projected onto the object to the one or more optical sensors comprises the use of a tiltable objective lens to create a magnification gradient across a field-of-view of the one or more optical sensors.
   23. The method of embodiment 22, wherein changing the deflection angle of light projected onto the object to the one or more optical sensors further comprises the use of a tiltable tube lens or a tiltable image sensor.
   24. The method of any one of embodiments 1 to 23, further comprising:
acquiring a first optical signal from an area of the object within the specified signal acquisition time using a first illumination light intensity;
acquiring a second optical signal from the area of the object within the specified signal acquisition time using a second illumination light intensity that is different from the first illumination light intensity; and
combining the first optical signal and the second optical signal to generate a combined optical signal having a higher dynamic range than the first optical signal or the second optical signal.
   25. The method of embodiment 24, wherein the first optical signal and the second optical signal are acquired using a same optical sensor in two separate signal acquisition steps within the specified signal acquisition time.
   26. The method of embodiment 24, wherein the first optical signal and the second optical signal are acquired using different optical sensors in a same signal acquisition step within the specified signal acquisition time.
   27. The method of embodiment 24, wherein the dynamic range of the combined optical signal is at least 2×, 5×, 10×, 15×, or 20× higher than the dynamic range of the first or second optical signals.
   28. The method of any one of embodiments 1 to 22, further comprising acquiring a plurality of optical signals from an area of the object within the specified signal acquisition time, wherein each of the plurality of optical signals is acquired using a different illumination condition.
   29. The method of embodiment 28, wherein the different illumination conditions comprise a different light intensity, a different illumination pattern, a different illumination wavelength, or any combination thereof.
   30. The method of embodiment 28 or embodiment 29, wherein the plurality of optical signals is acquired using a plurality of optical sensors in a same signal acquisition step within the specified signal acquisition time.
   31. The method of embodiment 28 or embodiment 29, wherein the plurality of optical signals is acquired using a same optical sensor in a plurality of different signal acquisition steps within the specified signal acquisition time.
   32. The method of embodiment 28 or embodiment 29, wherein the plurality of optical signals is acquired using a same optical sensor in a plurality of different signal acquisition steps at different times.
   33. The method of any one of embodiments 1 to 32, wherein a time-dependence of changing the deflection angle of light projected onto the one or more optical sensors is periodically or continuously adjusted to synchronize the change in deflection angle with changes in the relative motion between the object and the one or more optical sensors.
   34. The method of embodiment 33, wherein the time-dependence of changing the deflection angle of light projected onto the one or more optical sensors is periodically or continuously adjusted without the use of a feedback mechanism.
   35. The method of any one of embodiments 9 to 34, wherein the relative motion between the object and the one or more optical sensors comprises rotational motion in a two-dimensional plane, and the acquired optical signals correspond to two or more areas of the object that comprise a circular segment of the object.
   36. The method of any one of embodiments 9 to 34, wherein the relative motion between the object and the one or more optical sensors comprises a combination of linear and rotational motion in a two-dimensional plane, and the acquired optical signals correspond to two or more areas of the object that comprise a spiral segment of the object.
   37. The method of any one of embodiments 1 to 36, wherein the optical signal comprises a fluorescence signal.
   38. The method of any one of embodiments 1 to 37, wherein the object comprises a substrate, wafer, or flow cell for nucleic acid sequencing.
   39. A method for imaging comprising:
changing a deflection angle of light relayed within an optical system and projected onto one or more image sensors using at least one optical component having a time-dependent orientation to correct for relative motion between an object to be imaged and the one or more image sensors,
wherein the change in deflection angle results in formation of a static image of the object on the one or more image sensors for a specified image acquisition time.
   40. The method of embodiment 39, wherein the light projected onto the one or more image sensors comprises light that is transmitted, reflected, or emitted by the object.
   41. The method of embodiment 39, wherein illumination light is projected onto an area of the object that is greater than or equal to an area of a field-of-view of the one or more image sensors for the specified image acquisition time.
   42. The method of embodiment 41, wherein an angle of the illumination light projected onto the object is changed using at least one optical component having a time-dependent orientation to correct for relative motion between the object and a light source that provides the illumination light.
   43. The method of embodiment 42, wherein the illumination light projected onto the object comprises an area of substantially uniform illumination light intensity.
   44. The method of embodiment 42 or embodiment 43, wherein the light source comprises a laser.
   45. The method of embodiment 44, wherein the laser comprises a pulsed laser that is synchronized with image acquisition.
   46. The method of embodiment 42, wherein the illumination light projected onto the object provides structured illumination.
   47. The method of any one of embodiments 39 to 46, wherein changing the deflection angle of light projected onto the one or more image sensors is repeated for two or more image acquisition cycles, each cycle comprising an image acquisition step and a rewind step, to acquire images of two or more areas of the object.
   48. The method of embodiment 47, wherein the two or more areas are contiguous.
   49. The method of any one of embodiments 39 to 48, wherein the one or more image sensors have a same field-of-view.
   50. The method of any one of embodiments 39 to 48, wherein the one or more image sensors have different fields-of-view.
   51. The method of any one of embodiments 39 to 50, wherein the relative motion between the object and the one or more image sensors comprises linear motion, rotational motion, or any combination thereof, within a two-dimensional plane.
   52. The method of any one of embodiments 39 to 51, wherein the relative motion between the object and the one or more image sensors comprises rotational motion within a two-dimensional plane.
   53. The method of any one of embodiments 39 to 52, wherein changing the deflection angle of light projected onto the one or more image sensors comprises the use of two or more galvo-mirrors.
   54. The method of embodiment 53, wherein the two or more galvo-mirrors are positioned between an objective lens and a tube lens used to form the image on the one or more image sensors.
   55. The method of embodiment 53, wherein the two or more galvo-mirrors are positioned between a tube lens used to form the image and the one or more image sensors.
   56. The method of any one of embodiments 53 to 55, wherein each of the two or more galvo-mirrors have two tilt axes, and at least one of the two tilt axes is perpendicular to a two-dimensional plane within which the relative motion between the object and the one or more image sensors occurs.
   57. The method of any one of embodiments 39 to 52, wherein changing the deflection angle of light projected onto the one or more image sensors comprises the use of a rotational stage on which the one or more image sensors are mounted and a reflector comprising at least one axis of tilt.
   58. The method of embodiment 57, wherein the reflector comprises a dichroic mirror.
   59. The method of any one of embodiments 39 to 52, wherein changing the deflection angle of light projected onto the object to the one or more image sensors comprises the use of a polygon mirror, a micromirror array, an acousto-optic deflector, a liquid crystal element, a liquid crystal array, or any combination thereof.
   60. The method of any one of embodiments 39 to 52, wherein changing the deflection angle of light projected onto the one or more image sensors comprises the use of a tiltable objective lens to create a magnification gradient across a field-of-view of the one or more image sensors.
   61. The method of embodiment 60, wherein changing the deflection angle of light projected onto the one or more image sensors further comprises the use of a tiltable tube lens or a tiltable image sensor.
   62. The method of any one of embodiments 39 to 61, further comprising: acquiring a first image from an area of the object within the specified image acquisition time using a first illumination light intensity; acquiring a second image from the area of the object within the specified image acquisition time using a second illumination light intensity that is different from the first illumination light intensity; and combining the first image and the second image to generate a combined image having a higher dynamic range than either the first image or the second image.
   63. The method of embodiment 62, wherein the first image and the second image are acquired using a same image sensor in two separate image acquisition steps within the specified image acquisition time.
   64. The method of embodiment 62, wherein the first image and the second image are acquired using different image sensors in a same image acquisition step within the specified image acquisition time.
   65. The method of embodiment 62, wherein the dynamic range of the combined image is at least 2×, 5×, 10×, 15×, or 20× higher than the dynamic range of the first or second images.
   66. The method of any one of embodiments 39 to 61, further comprising acquiring a plurality of images from an area of the object within the specified image acquisition time, wherein each of the plurality of images is acquired using a different illumination condition.
   67. The method of embodiment 66, wherein the different illumination conditions comprise a different light intensity, a different illumination pattern, a different illumination wavelength, or any combination thereof.
   68. The method of embodiment 66 or embodiment 67, wherein the plurality of images is acquired using a plurality of image sensors in a same image acquisition step within the specified image acquisition time.
   69. The method of embodiment 66 or embodiment 67, wherein the plurality of images is acquired using a same image sensor in a plurality of different image acquisition steps within the specified image acquisition time.
   70. The method of embodiment 66 or embodiment 67, wherein the plurality of images is acquired using a same image sensor in a plurality of different image acquisition steps at different times.
   71. The method of any one of embodiments 39 to 70, wherein a time-dependence of changing the deflection angle of light projected onto the one or more image sensors is periodically or continuously adjusted to synchronize the change in deflection angle with changes in the relative motion between the object and the one or more image sensors.
   72. The method of embodiment 71, wherein the time-dependence of changing the deflection angle of light projected onto the one or more image sensors is periodically or continuously adjusted without the use of a feedback mechanism.
   73. The method of any one of embodiments 47 to 72, wherein the relative motion between the object and the one or more image sensors comprises rotational motion in a two-dimensional plane, and the images of the two or more areas of the object correspond to a circular segment of the object.
   74. The method of any one of embodiments 47 to 72, wherein the relative motion between the object and the one or more image sensors comprises a combination of linear and rotational motion in a two-dimensional plane, and the images of the two or more areas of the object correspond to a spiral segment of the object.
   75. The method of any one of embodiments 39 to 74, wherein the static image of the object comprises a fluorescence image.
   76. The method of any one of embodiments 39 to 75, wherein the object comprises a substrate, wafer, or flow cell for nucleic acid sequencing.
   77. A method for imaging comprising: changing a deflection angle of light relayed within an imaging system and projected onto one or more image sensors using at least one optical component having a time-dependent orientation to correct for relative motion between a substrate to be imaged and the one or more image sensors, wherein the change in deflection angle results in formation of a static image of the substrate on the one or more image sensors for a specified image acquisition time.
   78. The method of embodiment 77, wherein the substrate comprises a rotating wafer.
   79. The method of embodiment 77 or embodiment 78, wherein the substrate comprises a plurality of nucleic acid sequencing colonies attached to at least one surface of the substrate.
   80. The method of embodiment 79, wherein the plurality of nucleic acid sequencing colonies comprises beads that are attached to the at least one surface of the substrate.
   81. The method of any one of embodiments 77 to 80, wherein the image comprises a fluorescence image.
   82. The method of any one of embodiments 77 to 81, wherein the method is used to perform nucleic acid sequencing.
   83. A system comprising:
a detection unit comprising one or more optical components and one or more optical sensors that are optically coupled to an object; and
a counter-scan unit configured to change a deflection angle of light relayed within the counter-scan unit and projected onto the one or more optical sensors using at least one optical component having a time-dependent orientation to correct for relative motion between the object and the one or more optical sensors, thereby delivering a motion-invariant optical signal to the one or more optical sensors for a specified signal acquisition time.
   84. The system of embodiment 83, further comprising an illumination unit comprising a radiation source and one or more optical components configured to project illumination light onto the object.
   85. The system of embodiment 83 or embodiment 84, wherein the light projected onto the one or more optical sensors comprises light that is transmitted, reflected, or emitted by the object.
   86. The system of any one of embodiments 83 to 85, wherein illumination light is projected onto an area of the object that is greater than or equal to an area of a field-of-view of the one or more optical sensors for the specified signal acquisition time.
   87. The system of embodiment 84 or embodiment 86, wherein an angle of the illumination light projected onto the object is changed using at least one optical component having a time-dependent orientation to correct for relative motion between the object and a light source that provides the illumination light.
   88. The system of any one of embodiments 84 to 87, wherein the illumination unit and the detection unit comprise different objective lenses.
   89. The system of any one of embodiments 84 to 87, wherein the illumination unit and the detection unit comprise a common objective lens.
   90. The system of any one of embodiments 87 to 89, wherein the system comprises a first counter-scan unit for changing the angle of the illumination light projected onto the object, and a second counter-scan unit for changing the deflection angle of light projected onto the one or more optical sensors.
   91. The system of any one of embodiments 86 to 90, wherein the illumination light projected onto the object comprises an area of substantially uniform light intensity.
   92. The system of any one of embodiments 83 to 91, wherein the radiation source comprises a laser.
   93. The system of embodiment 92, wherein the laser comprises a pulsed laser that is synchronized with signal acquisition.
   94. The system of any one of embodiments 87 to 90, wherein the illumination light projected onto the object comprises structured illumination.
   95. The system of any one of embodiments 83 to 94, wherein the counter-scan unit is configured to repeat changing the deflection angle of light projected onto the one or more optical sensors for two or more signal acquisition cycles, each cycle comprising a signal acquisition step and a rewind step, to acquire optical signals corresponding to two or more areas of the object.
   96. The system of embodiment 95, wherein the two or more areas are contiguous.
   97. The system of any one of embodiments 83 to 96, wherein the one or more optical sensors have a same field-of-view.
   98. The system of any one of embodiments 83 to 96, wherein the one or more optical sensors have different fields-of-view.
   99. The system of any one of embodiments 83 to 98, wherein the relative motion between the object and the one or more optical sensors comprises linear motion, rotational motion, or any combination thereof within a two-dimensional plane.
   100. The system of any one of embodiments 83 to 99, wherein the relative motion between the object and the one or more optical sensors comprises rotational motion within a two-dimensional plane.
   101. The system of any one of embodiments 83 to 100, wherein the counter-scan unit comprises two or more galvo-mirrors configured to change the deflection angle of light projected onto the one or more optical sensors.
   102. The system of embodiment 101, wherein the two or more galvo-mirrors are positioned between an objective lens and a tube lens used to relay the optical signal to the one or more optical sensors.
   103. The system of embodiment 101, wherein the two or more galvo-mirrors are positioned between a tube lens used to relay the optical signal and the one or more optical sensors.
   104. The system of any one of embodiments 101 to 103, wherein each of the two or more galvo-mirrors have two tilt axes, and at least one of the two tilt axes is perpendicular to a two-dimensional plane within which the relative motion between the object and the one or more optical sensors occurs.
   105. The system of any one of embodiments 83 to 104, wherein the counter-scan unit comprises a rotational stage on which the one or more optical sensors are mounted and a reflector comprising at least one axis of tilt.
   106. The system of embodiment 105, wherein the reflector comprises a dichroic mirror.
   107. The system of any one of embodiments 83 to 106, wherein the counter-scan unit comprises a polygon mirror, a micromirror array, an acousto-optic deflector, a liquid crystal element, a liquid crystal array, or any combination thereof.
   108. The system of any one of embodiments 83 to 107, wherein the counter-scan unit comprises a tiltable objective lens configured to create a magnification gradient across a field-of-view of the one or more optical sensors.
   109. The system of embodiment 108, wherein the counter-scan unit further comprises a tiltable tube lens or a tiltable optical sensor that are collectively configured to create the magnification gradient across the field-of-view of the one or more optical sensors.
   110. The system of any one of embodiments 83 to 109, wherein the system is configured to:
acquire a first optical signal within the specified signal acquisition time using a first illumination light intensity;
acquire a second optical signal within the specified signal acquisition time using a second illumination light intensity that is different from the first illumination light intensity; and
combine the first optical signal and the second optical signal to generate a combined optical signal having a higher dynamic range than the first optical signal or the second optical signal.
   111. The system of embodiment 110, wherein the dynamic range of the combined optical signal is at least 2×, 5×, 10×, 15×, or 20× higher than the dynamic range of the first or second optical signals.
   112. The system of any one of embodiments 83 to 111, wherein a time-dependence for changing the deflection angle of light projected onto the one or more optical sensors is periodically or continuously adjusted to synchronize the change in deflection angle with changes in the relative motion between the object and the one or more optical sensors.
   113. The system of embodiment 112, wherein the time-dependence of changing the deflection angle of light projected onto the one or more optical sensors is periodically or continuously adjusted without the use of a feedback mechanism.
   114. The system of any one of embodiments 95 to 113, wherein the relative motion between the object and the one or more optical sensors comprises rotational motion in a two-dimensional plane, and the two or more acquired optical signals correspond to a circular segment of the object.
   115. The system of any one of embodiments 95 to 113, wherein the relative motion between the object and the one or more optical sensors comprises a combination of linear and rotational motion in a two-dimensional plane, and the two or more acquired optical signals correspond to a spiral segment of the object.
   116. The system of any one of embodiments 83 to 115, wherein the optical signal comprises a fluorescence signal.
   117. The system of any one of embodiments 83 to 116, wherein the one or more optical sensors comprise one or more image sensors, and the motion-invariant delivery of the optical signal to the one or more image sensors forms a static image on the one or more image sensors for a specified image acquisition period.
   118. The system of any one of embodiments 83 to 117, wherein the object to be imaged comprises a substrate, wafer, or flow cell for nucleic acid sequencing.
   119. A system comprising:
a detection unit comprising one or more optical components and one or more image sensors that are optically coupled to a substrate to be imaged; and
a counter-scan unit configured to change a deflection angle of light relayed within the counter-scan unit and projected onto the one or more image sensors using at least one optical component having a time-dependent orientation to correct for relative motion between the substrate and the one or more image sensors, thereby forming a static image on the one or more image sensors for a specified image acquisition time.
   120. The system of embodiment 119, wherein the substrate comprises a rotating wafer.
   121. The system of embodiment 119 or embodiment 120, wherein the substrate comprises a plurality of nucleic acid sequencing colonies attached to at least one surface of the substrate.
   122. The system of embodiment 121, wherein the plurality of nucleic acid sequencing colonies comprises beads that are attached to the at least one surface of the substrate.
   123. The system of any one of embodiments 119 to 122, wherein the image comprises a fluorescence image.
   124. The system of any one of embodiments 119 to 123, wherein the system is used to perform nucleic acid sequencing.
   125. A non-transitory computer-readable storage medium storing one or more programs, the one or more programs comprising instructions which, when executed by one or more processors of a system, cause the system to perform the method of any one of embodiments 1 to 82.

It should be understood from the foregoing that, while particular implementations of the disclosed methods and systems have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations, and equivalents.

What is claimed is:

1. A method comprising:
changing a deflection angle of light relayed within an optical system and projected onto one or more optical sensors using at least one optical component having a time-dependent orientation to correct for relative motion between an object and the one or more optical sensors,
wherein the change in deflection angle results in delivery of a motion-invariant optical signal to the one or more optical sensors for a specified signal acquisition time.

2. The method of claim 1, wherein the light projected onto the one or more optical sensors comprises light that is transmitted, reflected, or emitted by the object.

3. The method of claim 1, wherein illumination light is projected onto an area of the object that is greater than or equal to an area of a field-of-view of the one or more optical sensors for the specified signal acquisition time.

4. The method of claim 1, wherein an angle of illumination light projected onto the object is changed using at least one optical component having a time-dependent orientation to correct for relative motion between the object and a light source that provides the illumination light.

5. The method of claim 4, wherein the illumination light projected onto the object provides structured illumination.

6. The method of claim 1, wherein changing the deflection angle of light projected onto the one or more optical sensors is repeated for two or more signal acquisition cycles, each cycle comprising a signal acquisition step and a rewind step, to acquire optical signals corresponding to two or more areas of the object.

7. The method of claim 6, wherein the two or more areas are contiguous.

8. The method claim 6, wherein the relative motion between the object and the one or more optical sensors comprises rotational motion in a two-dimensional plane, and the acquired optical signals correspond to two or more areas of the object that comprise a spiral segment of the object.

9. The method of claim 1, wherein the one or more optical sensors have a same field-of-view.

10. The method of claim 1, wherein the relative motion between the object and the one or more optical sensors comprises linear motion, rotational motion, or any combination thereof within a two-dimensional plane.

11. The method of claim 1, wherein the relative motion between the object and the one or more optical sensors comprises rotational motion within a two-dimensional plane.

12. The method of claim 1, wherein changing the deflection angle of light projected onto the one or more optical sensors comprises the use of two or more galvo-mirrors.

13. The method of claim 12, wherein each of the two or more galvo-mirrors have two tilt axes, and at least one of the two tilt axes is perpendicular to a two-dimensional plane within which the relative motion between the object and the one or more optical sensors occurs.

14. The method of claim 1, wherein changing the deflection angle of light projected onto the one or more optical sensors comprises the use of a rotational stage on which the one or more optical sensors are mounted and a reflector comprising at least one axis of tilt.

15. The method of claim 14, wherein the reflector comprises a dichroic mirror.

16. The method of claim 1, wherein changing the deflection angle of light projected onto the object to the one or more optical sensors comprises the use of a tiltable objective lens to create a magnification gradient across a field-of-view of the one or more optical sensors.

17. The method of claim 1, further comprising:
acquiring a first optical signal from an area of the object within the specified signal acquisition time using a first illumination light intensity;
acquiring a second optical signal from the area of the object within the specified signal acquisition time using a second illumination light intensity that is different from the first illumination light intensity; and
combining the first optical signal and the second optical signal to generate a combined optical signal having a higher dynamic range than the first optical signal or the second optical signal.

18. The method of claim 17, wherein the first optical signal and the second optical signal are acquired using a same optical sensor in two separate signal acquisition steps within the specified signal acquisition time.

19. The method of claim 17, wherein the optical signal comprises a fluorescence signal.

20. The method of claim 1, wherein the object comprises a substrate, wafer, or flow cell for nucleic acid sequencing.
